(19) United States
(12) Patent Application Publication
(10) Pub. No.: US 2025/0259055 A1
(43) Pub. Date: Aug. 14, 2025

(54) NEURAL NETWORK WITH POINT GRID CONVOLUTIONAL LAYER

(71) Applicant: Intel Corporation, Santa Clara, CA (US)

(72) Inventors: Anbang Yao, Beijing (CN); Chao Li, Beijing (CN); Yangyuxuan Kang, Beijing (CN); Dongqi Cai, Beijing (CN); Xiaolong Liu, Beijing (CN); Yi Yang, Gilbert, AZ (US); Yurong Chen, Beijing (CN)

(73) Assignee: Intel Corporation, Santa Clara, CA (US)

(21) Appl. No.: 18/857,081

(22) PCT Filed: May 16, 2022
(86) PCT No.: PCT/CN2022/093082

§ 371 Date: Oct. 15, 2024

(51) Int. Cl. G06N 3/08; G06F 17/15; G06N 3/0464

(52) U.S. Cl. CPC G06N 3/08; G06F 17/15; G06N 3/0464

(57) ABSTRACT

A PGConv layer extract features from grid-structured data samples. The PGConv layer may receive an input feature map including a grid representation of an object, which is generated from a graph representation of the object. The grid representation includes node elements that are arranged in a grid pattern. The PGConv layer may perform padding on the grid representation to generate an IFM that includes the node elements and the additional node elements. An additional node element may have a value of zero or a value of a node element in the grid representation. The PGConv layer may also generate an attentive kernel that includes attentive weights determined based on the IFM. The PGConv layer may generate a dynamic kernel based on the attentive kernel and a convolutional kernel generated through training. The PGConv layer may further perform MAC operations on the IFM and the dynamic kernel and generate an OFM.

### CROSS REFERENT TO PRIOR APPLICATION

This application is a national stage application under 35 U.S.C. § 371 of International Application No. PCT/CN2022/093082, filed May 16, 2022, titled, “NEURAL NETWORK WITH POINT GRID CONVOLUATIONAL LAYER,” which is incorporated herein by reference in its entirety.

### TECHNICAL FIELD

This disclosure relates generally to deep neural networks (DNNs), and more specifically, to DNNs with point grid convolutional (PGConv) layers.

### BACKGROUND

DNNs are used extensively for a variety of artificial intelligence (AI) applications ranging from computer vision to speech recognition and natural language processing due to their ability to achieve high accuracy. One type of DNN is graph convolutional network (GCN). GCN is one of the prevailing solutions for various AI applications, such as human pose lifting, skeleton based human action recognition, mesh reconstruction, traffic navigation, social network analysis, recommend system, scientific computing, and so on.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example layer structure of a convolutional neural network (CNN), in accordance with various embodiments.

FIG. 2 is a block diagram of an example PGConv layer, in accordance with various embodiments.

FIG. 3 illustrates an example point grid convolution, in accordance with various embodiments.

FIGS. 4A-4C illustrates an example semantic grid transformation, in accordance with various embodiments.

FIGS. 5A-5D illustrates various padding methods, in accordance with various embodiments.

FIG. 6 illustrates an example dynamic convolution, in accordance with various embodiments.

FIG. 7 illustrates an example PGConv layer including multiple branches, in accordance with various embodiments.

FIG. 8 is a block diagram of a point grid system, in accordance with various embodiments.

FIG. 9 illustrates an example three-dimensional (3D) pose estimation based on a two-dimensional (2D) image, in accordance with various embodiments.

FIG. 10 illustrates a deep learning (DL) environment, in accordance with various embodiments.

FIG. 11 is a flowchart showing a method of point grid convolution facilitated by padding, in accordance with various embodiments.

FIG. 12 is a flowchart showing a method of dynamic point grid convolution, in accordance with various embodiments.

FIG. 13 is a block diagram of an example computing device, in accordance with various embodiments.

### DETAILED DESCRIPTION

### Overview

GCNs are a variant of CNNs. GCNs are adopted to operate on data samples represented in the form of irregular graphic structures, such as images. Taking pose lifting network for example, pose lifting network is a specific type of GCN. A pose lifting network is usually trained to estimate 3D human pose given locations of body joints detected from a 2D input. Estimating 3D human pose from images and videos has a wide range of applications such as human action recognition, human robot/computer interaction, augmented reality, animation and gaming. Generally, existing pose lifting networks can be grouped into four solution families: (1) Fully Connected Network (FCN); (2) Semantic Graph Convolution Network (SGCN); (3) Locally Connected Network (LCN); and (4) other variants of FCN, SGCN and LCN. All these pose lifting networks operate based on data samples represented in the form of irregular graph structures.

However, the usage of such data samples can limit the performance of GCNs in certain image-based applications. Also, it can lead to irregular workloads, e.g., irregular sparse tensor operations. These irregular workloads prevent GCNs from being efficiently executed on many AI processors, such as GPUs (graphics processing units), CPUs (central processing units), VPUs (vision processing units), TPUs (tensor processing units), and so on. Therefore, improved techniques for convolutional operations on graph-structured data are needed.

Embodiments of the present disclosure may improve on at least some of the challenges and issues described above by providing DNNs with PGConv layers. In various embodiments of the present disclosure, graph-structured data is converted to data with regular structures, e.g., grid-structured data. A PGConv layer can perform convolutions on grid-structured data samples to extract features from the grid-structured data samples. The PGConv layer may perform padding on a grid-structured data sample to preserve the spatial size of the grid-structured data sample.

For example, the PGConv layer may receive an IFM that includes a grid-structured data sample that includes grid nodes (also referred to as “node elements”) that are arranged in a grid pattern. The PGConv layer can add additional node elements to the IFM to generate an expanded feature map (EFM). The EFM has a larger spatial size than the IFM. In some embodiments, the PGConv layer generates the EFM through zero padding, in which additional node elements having values of zero are added to one or more edges of the IFM. In other embodiments, the PGConv layer generates the EFM through circular padding, in which additional node elements having values of node elements on an edge of the IFM are added to the opposite edge of the IFM. The PGConv layer may use a combination of zero padding and circular padding. The EFM may have different grid pattern from the IFM. In an example, the IFM may have a 2D grid pattern versus the EFM may have a 3D grid pattern. The PGConv layer can further perform convolution with the EFM and a kernel to generate an output feature map (OFM). The OFM may have the same spatial size as the IFM.

The padding can address problems caused by shrinkage of feature map during convolution. Due to the shrinkage of feature map during convolution, the number of times convolutions could be performed is limited, especially in scenarios where the IFM has a relatively small spatial size. Also, the node elements on the corners and the edges of the IFM are used much less than the node elements in the middle. The padding can preserve the size of the IFM and increases the contribution of the node elements at the border of the IFM by bringing them into the middle of the EFM.

A PGConv layer can perform dynamic point grid convolutions, also referred to hereinafter as dynamic convolutions. The PGConv layer may use an attention function to generate an attention for an IFM or EFM. The attention may include one or more attentive kernels including attentive weights determined based on the IFM or EFM. The PGConv layer can use the attention to scale the convolutional kernel, which is determined from the training of the PGConv layer. Convolutional kernels are static as their weights do not change as the IFM changes. As the attentive kernels changes as the IFM changes, the scaled convolutional kernel adopts the dynamic nature of the attention. The PGConv layer can perform a dynamic convolution with the IFM (or EFM generated from the IFM) and the scaled convolutional kernel. Such dynamic convolution is input-dependent and position-aware and can have better feature learning capacity than conventional convolutions. Thus, the dynamic convolution can be more advantageous in various applications, such as image-based applications.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example CNN Layer Structure

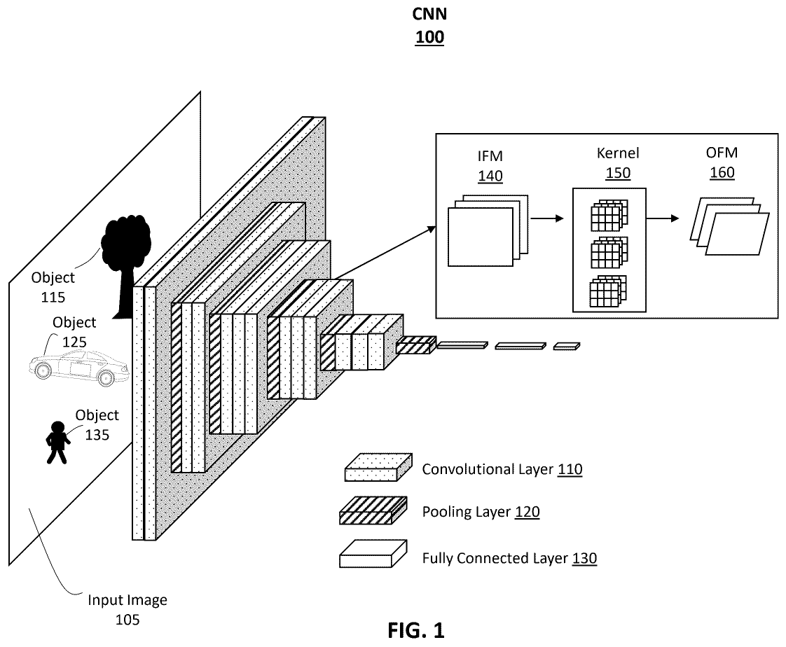

FIG. 1 illustrates an example layer structure of a CNN 100, in accordance with various embodiments. For purpose of illustration, the CNN 100 is trained to receive images and output classifications of objects in the images. In the embodiment of FIG. 1, the CNN 100 receives an input image 105 that includes objects 115, 125, and 135. The CNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the CNN 100 may include fewer, more, or different layers.

The convolutional layers 110 summarize the presence of features in the input image 105. In the embodiment of FIG. 1, the first layer of the CNN 100 is a convolutional layer 110. The convolutional layers 110 function as feature extractors. A convolutional layer 110 can receive an input and outputs features extracted from the input. In an example, a convolutional layer 110 performs a convolution to an IFM 140 by using a kernel 150, generates an OFM 160 from the convolution, and passes the OFM 160 to the next layer in the sequence. The IFM 140 may include a plurality of IFM arrays, each of which may corresponds to a channel of the IFM 140 (i.e., input channel). An IFM array includes a plurality of input elements arranged in rows and columns. The number of rows and number of columns may define a spatial size of the IFM 140. For the first convolutional layer 110, which is also the first layer of the CNN 100, the IFM 140 is the input image 105. For the other convolutional layers, the IFM 140 may be an output of another convolutional layer 110 or an output of a pooling layer 120.

The kernel 150 may be a convolutional kernel. In the embodiments of FIG. 1, the kernel 150 includes three convolutional filters 155 (individually referred to as convolutional filter 155). In other embodiments, the kernel 150 may include a different number of convolutional filters 155. The number of convolutional filters 155 may equal the number of channels in the OFM 160. Each convolutional filter 155 includes a plurality of weight arrays, which may correspond to a plurality of channels of the IFM 140. The number of weight arrays in a convolutional filter 155 may equal the number of channels in the IFM 140. A weight array includes weights arranged in rows and columns. The number of rows and number of columns may define a spatial size of the kernel 150. The values of the weights may be determined through training the CNN 100.

The OFM 160 may include a plurality of IFM arrays, each of which may corresponds to a channel of the OFM 160 (i.e., output channel). An OFM array includes a plurality of output elements arranged in rows and columns. The number of rows and number of columns may define a spatial size of the OFM 160. The spatial size of the OFM 160 may be smaller than the spatial size of the IFM 140. In some embodiments, the spatial size of the IFM 140 can be preserved through padding.

A convolution may be a linear operation that involves the multiplication of a weight operand in the kernel 150 with a weight operand-sized patch of the IFM 140. A weight operand may be a weight matrix in the kernel 150, such as a 2-dimensional array of weights, where the weights are arranged in columns and rows. Weights can be initialized and updated by backpropagation using gradient descent. The magnitudes of the weights can indicate importance of the kernel 150 in extracting features from the IFM 140. A weight operand can be smaller than the IFM 140. The multiplication can be an element-wise multiplication between the weight operand-sized patch of the IFM 140 and the corresponding weight operand, which is then summed, always resulting in a single value. Because it results in a single value, the operation is often referred to as the “scalar product.”

In some embodiments, using a weight operand smaller than the IFM 140 is intentional as it allows the same weight operand (set of weights) to be multiplied by the IFM 140 multiple times at different points on the IFM 140. Specifically, the weight operand is applied systematically to each overlapping part or weight operand-sized patch of the IFM 140, left to right, top to bottom. The result from multiplying the weight operand with the IFM 140 one time is a single value. As the weight operand is applied multiple times to the IFM 140, the multiplication result is a two-dimensional array of output values that represent a weight operanding of the IFM 140. As such, the 2-dimensional output array from this operation is referred to a “feature map.”

In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculates the convolution of each of them with each of the weight operands. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new weight operands and generates a new feature map. The new feature map may also be normalized and resized. The new feature map can be weight operanded again by a further subsequent convolutional layer 110, and so on.

In some embodiments, a convolutional layer 110 has four hyperparameters: the number of weight operands, the size F weight operands (e.g., a weight operand is of dimensions F×F×D pixels), the S step with which the window corresponding to the weight operand is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depth-wise separable convolution, transposed convolution, and so on. The CNN 100 includes 16 convolutional layers 110. In other embodiments, the CNN 100 may include a different number of convolutional layers.

The pooling layers 120 down-sample feature maps generated by the convolutional layers, e.g., by summarizing the presents of features in the patches of the feature maps. A pooling layer 120 is placed between two convolutional layers 110: a preceding convolutional layer 110 (the convolutional layer 110 preceding the pooling layer 120 in the sequence of layers) and a subsequent convolutional layer 110 (the convolutional layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolutional layer 110 and applies a pooling operation to the feature maps. The pooling operation reduces the size of the feature maps while preserving their important characteristics. Accordingly, the pooling operation improves the efficiency of the CNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolutional layer 110 for further feature extraction. In some embodiments, the pooling layer 120 operates upon each feature map separately to create a new set of the same number of pooled feature maps.

The fully connected layers 130 are the last layers of the CNN. The fully connected layers 130 may be convolutional or not. The fully connected layers 130 receives an input operand. The input operand defines the output of the convolutional layers 110 and pooling layers 120 and includes the values of the last feature map generated by the last pooling layer 120 in the sequence. The fully connected layers 130 applies a linear combination and an activation function to the input operand and generates an individual partial sum. The individual partial sum may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and returns an operand of size N, where N is the number of classes in the image classification problem. In the embodiment of FIG. 1, N equals 3, as there are three objects 115, 125, and 135 in the input image. Each element of the operand indicates the probability for the input image 105 to belong to a class. To calculate the probabilities, the fully connected layers 130 multiply each input element by weight, makes the sum, and then applies an activation function (e.g., logistic if N=2, softmax if N>2). This is equivalent to multiplying the input operand by the matrix containing the weights. In an example, the individual partial sum includes three probabilities: a first probability indicating the object 115 being a tree, a second probability indicating the object 125 being a car, and a third probability indicating the object 135 being a person. In other embodiments where the input image 105 includes different objects or a different number of objects, the individual partial sum can be different.

### Example PGConv Layer

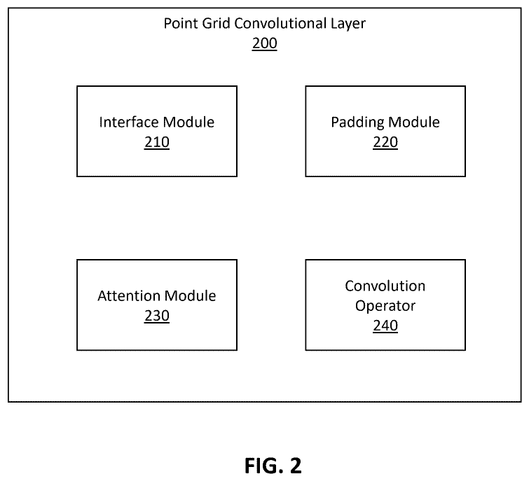

FIG. 2 is a block diagram of an example PGConv layer 200, in accordance with various embodiments. The PGConv layer 200 can extract features from grid-structured data samples through convolutional operations, such as dynamic convolutions. A grid-structured data sample may be converted from a graph-structured data sample (e.g., an image) through semantic grid transformation. The PGConv layer 200 may be an embodiment of one or more convolutional layers 110 in FIG. 1. As shown in FIG. 2, the PGConv layer 200 includes an interface module 210, a padding module 220, an attention module 230, a convolutional operator 240, and a convolution operator 250. In other embodiments, alternative configurations, different or additional components may be included in the PGConv layer 200. For instance, the PGConv layer 200 may include more than one convolution operators. Further, functionality attributed to a component of the PGConv layer 200 may be accomplished by a different component included in the PGConv layer 200 or by a different system.

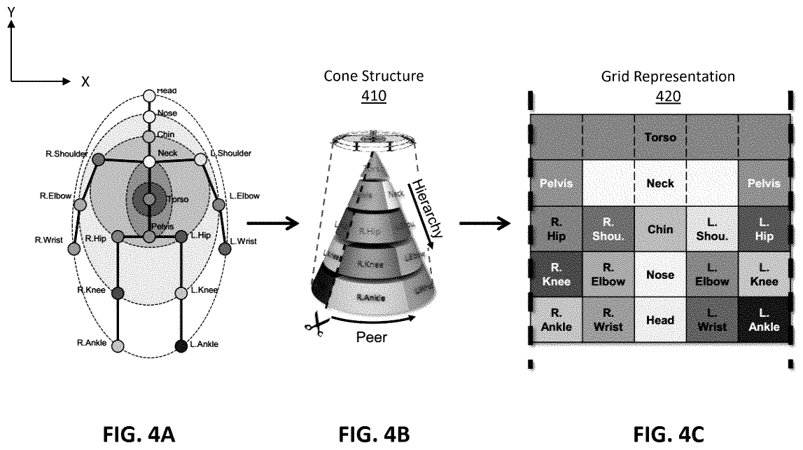

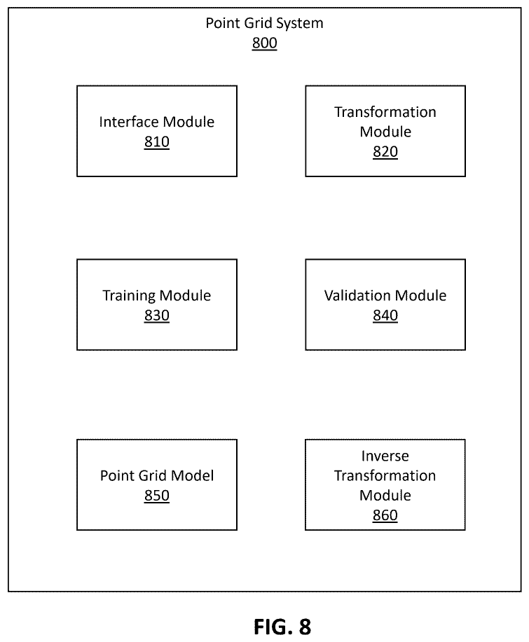

The interface module 210 facilitates communications of the PGConv layer 200 with other systems. In some embodiments, the interface module 210 establishes communications of the PGConv layer 200 to receive IFMs from which the PGConv layer 200 will extract features. An IFM may be a grid-structured data sample, which may be converted from graph-structured data through semantic grid transformation, such as the semantic grid transformation illustrated in FIGS. 4A-4C. In some embodiments, an IFM includes a grid representation of an object that is converted from an image of the object. The object may be a person, animal, plant, tree, building, vehicle, street, or other types of objects. The PGConv layer 200 may receive the grid-structured data from a transformation module (e.g., the transformation module 820 described below in conjunction with FIG. 8). The interface module 210 may also support the PGConv layer 200 to OFMs generated by the PGConv layer 200 to other systems or devices. For instance, the interface module 210 may send a feature map to another layer of a DNN that includes the PGConv layer 200, to another DNN, or to a module that can use the feature map for various applications, such as pose estimation, action recognition, 3D mesh reconstruction, traffic navigation, social network analysis, recommend system, scientific computing, and so on. In an example, the interface module 210 may send a feature map to an inverse transformation module (e.g., the inverse transformation module 860 described below in conjunction with FIG. 8) for generating a graph, e.g., a 3D graph representing a pose.

The padding module 220 performs padding on IFMs received by the interface module 210 to generate EFMs. In some embodiments, the padding module 220 receives an IFM that includes a grid representation of an object. The grid representation, an example of which is shown in FIG. 4C, includes a plurality of node elements arranged in a grid pattern. The grid pattern may be a 2D pattern, e.g., a pattern including elements arranged in rows and columns. A node element may be assigned to one or more of the elements of the grid structure. The padding module 220 adds one or more additional node elements to the grid representation to form an EFM for a convolution to be performed by the convolution operator 240. The EFM includes the node elements of the grid representation as well as the additional node elements.

The padding may ensure that an OFM resulting from the convolution has the same spatial size as the IFM. Without the padding, the OFM would have a smaller spatial size than the IFM. For instance, for an IFM Dⁱⁿ∈R^{H×P×C}^{ᵢₙ}, which has a spatial size of H×P and Cᵢₙ channels, and a kernel W∈R^{K×K×C}^{ᵢₙ}^{×C}^{ₒᵤₜ}, which has Cₒᵤₜ filters with a spatial size of K×K, the dimensions of the OFM resulting from a convolution operation is (H−K+1)×(P−K+1). In a scenario where H=8, P=8, and K=3, the OFM would have a spatial size of (6×6), which is smaller than the spatial size of the IFM. As the feature map shrinks as convolution is performed, there can be an upper limit to the number of times convolutions could be performed before the input reduces to nothing, which can prevent development of deeper CNNs, e.g., CNNs having more convolutional layers. Also, the input elements on the corners and the edges of the IFM are used much less than those in the middle and therefore provide less contribution to the OFM than those in the middle. Padding can solve the problems, as padding can preserve the size of the IFM and increases the contribution of the input elements at the border of the IFM by bringing them into the middle of the EFM. In an example where additional input elements are added to all the four sides of the IFM, the IFM can be expanded to an EFM having a spatial size of (H+2)×(P+2). Accordingly, the OFM has a spatial size (H+2−K+1)×(P+2−K+1). In the scenario where H=8, P=8, and K=3, the OFM's spatial size would be (8×8), which is the same as the spatial size of the IFM. In other scenarios, H or P may have other values. Also, the value of H may be different from the value of P.

In some embodiments, the padding module 220 may perform zero padding on an IFM by adding zero-valued node elements to the IFM. In an embodiment, the padding module 220 may added the zero-valued node elements to one or more sides of the IFM. For example, the padding module 220 may add two rows of zero-valued node elements and two columns of zero-valued node elements to the IFM in a way that the original input elements of the IFM are enclosed by the zero-valued node elements. In another embodiment, the padding module 220 may added the zero-valued node elements to other locations of the IFM. In addition to or alternative to zero-valued node elements, the padding module 220 may add non-zero-valued node elements to the IFM. For instance, the padding module 220 may generate additional node elements based on the values of the node elements on a side (e.g., an edge) of the IFM and added the additional node elements to the opposite side of the IFM. The value of an additional node element may equal to the value of a node element on the edge. The padding can result in the two edges having same values so that the two edges can be connected to form a 3D circular structure, such as a torus or hollow cylinder. Such padding is referred to as “circular padding.”

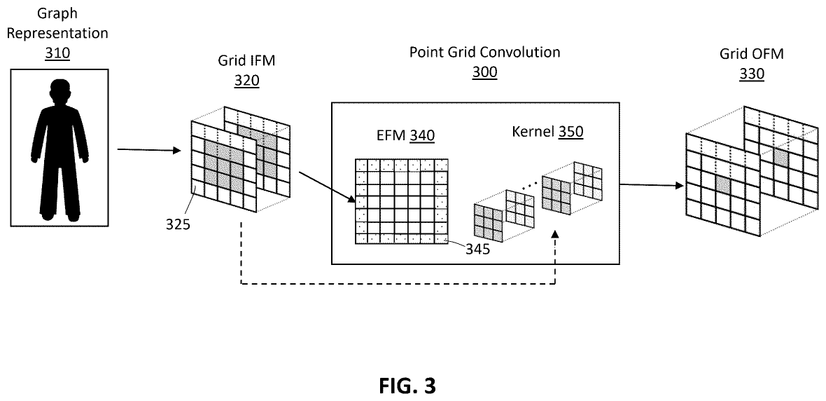

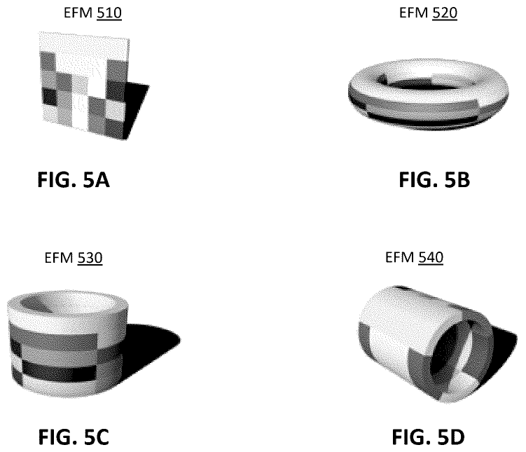

The padding module 220 can use different padding methods to generate EFMs having different patterns from an IFM. In some embodiments where the IFM is a 2D grid having four sides (e.g., top side, bottom side, left side, and right side), the padding module 220 may perform zero padding on all the four sides of the IFM and the resulting EFM will also have a 2D grid pattern but a bigger spatial size than the IFM. The padding module 220 may perform circular padding on all the four sides and generates an EFM having a torus grid pattern. The padding module 220 may also perform a mixture of zero padding and circular padding on the IFM. For example, the padding module 220 performs circular padding on the left side and right side but zero padding on the top side and bottom side and generates an EFM having a bucket grid pattern. As another example, the padding module 220 performs zero padding on the left side and right side but circular padding on the top side and bottom side and generates an EFM having a pipe grid pattern. In other embodiments, the padding module 220 can generate EFMs having other shapes. More details regarding padding are described below in conjunction with FIGS. 3 and 5A-D.

The attention module 230 generates attentive kernels based on IFMs or EFMs to facilitate dynamic convolutions. The attention module 230 may an attention α for an IFM or EFM. The attention α may be spatial adaptive. For instance, the attention α may include one or more attentive kernels, and different attentive kernels in the attention α may have different dimensions. An attentive kernel includes attentive weights. The attention module 230 may determine the values of the attentive weights based on the IFM or EFM. The attention module 230 can provide the attention to the convolutional operator 240, which can use the attention α to scale a convolutional kernel. The scaled convolution kernel and the IFM or EFM can be used, e.g., by the convolution operator 250, to perform a dynamic convolution.

Some of the description below with respect to generation of attention α refers to IFM. However, the attention module 230 can also generate an attention α based on an EFM from the padding module 220. In addition to the IFM, the attention module 230 may also generate the attentive kernels based on the convolution kernel. In some embodiments, the attention module 230 may generate multiple attentive kernels along multiple dimensions of the convolutional kernel. For instance, the attention module 230 generates three attentive kernels including a spatial attentive kernel αₛ, an input channel kernel α_{c}, and an output channel kernel α_{f}. The spatial attentive kernel αₛ corresponds to the spatial size of a convolutional filter in the convolutional kernel, the input channel kernel α_{c} corresponds to the input channel dimension of the convolutional kernel, the output channel kernel α_{f} corresponds to the output channel dimension of the convolutional kernel. In an example where the convolutional kernel is denoted as W∈R^{K×K×C}^{ᵢₙ}^{×C}^{ₒᵤₜ}, the three attentive kernels can be denoted as:

$$\begin{matrix}{α}_{s} ∈ {R}^{K \times K \times 1 \times 1} \\ {α}_{c} ∈ {R}^{1 \times 1 \times {C}_{in} \times 1} \\ {α}_{f} ∈ {R}^{1 \times 1 \times {C}_{out} \times 1}\end{matrix}$$

In some embodiments (e.g., embodiments where the PGConv layer 200 performs dynamic convolutions), the attention module 230 may generate αₛ∈R^{K×K×1×1} for each node element. For an example IFM that has a spatial size of H×P (i.e., H×P number of node elements for each channel), the attention module 230 may generate α∈R^{K×K×H×P}. The dimensions of the attentive kernels are examples. In other embodiments, the attentive kernels may have other dimensions.

In some embodiments, the attention module 230 applies an attention function π on an IFM Dⁱⁿ and the attention function returns an attention α, which can be formulated as:

α=π(Dⁱⁿ)

The attention function may include one or more parameters. The parameters can be determined during the training of the PGConv layer 200. In some embodiments, the attention function includes pooling function, attention function, batch normalization function, function for operation of fully connection layers, other functions, or some combination thereof.

In an example process of generating an attention α, the attention module 230 may generate a sequence of transformed feature maps (TFMs) through various operations. In some embodiments, the attention module 230 performs a pooling operation on an IFM to generate the first TFM, which is also referred to as a channel descriptor. The pooling operation may be an average pooling operation, such as a global pooling operation. In an average pooling operation, the attention module 230 may perform a spatial aggregation of the IFM by replacing the input elements in each channel of the IFM with an average of the input elements in that channel. The attention module 230 can further perform a transformation on the channel descriptor, e.g., by using a fully connected layer (e.g., the fully connected layer 130 in FIG. 1), a batch normalizer, and an activation function. The fully connected layer can reduce a dimension of the channel descriptor, e.g., reduces the channel size Cᵢₙ to Cᵢₙ/r, where r is a squeeze ratio. The batch normalizer can perform a batch normalization operation on the output of the fully connected layer. Further, the activation function can apply an activation function (e.g., ReLU, etc.) on the output of the batch normalizer. The output of the activation function is the second TFM, which is also referred to as abstraction descriptor.

The abstraction descriptor can be further provided to a group of fully connected layers and activation functions to generate the attentive kernels. In an example, the attention module 230 includes three pairs of fully connected layers and activation functions. Each pair includes a fully connected layer and an activation function (e.g., a sigmoid activation function) and computes a different attentive kernel. The fully connected layer in a pair can map the abstraction description from the reduced channel size Cᵢₙ/r to the corresponding diminishability of the corresponding attentive kernel. The output of the fully connected layer can be sent to the activation function in the pair. The activation function can scale the output of the fully connected layer to produce the values in the corresponding attentive kernel.

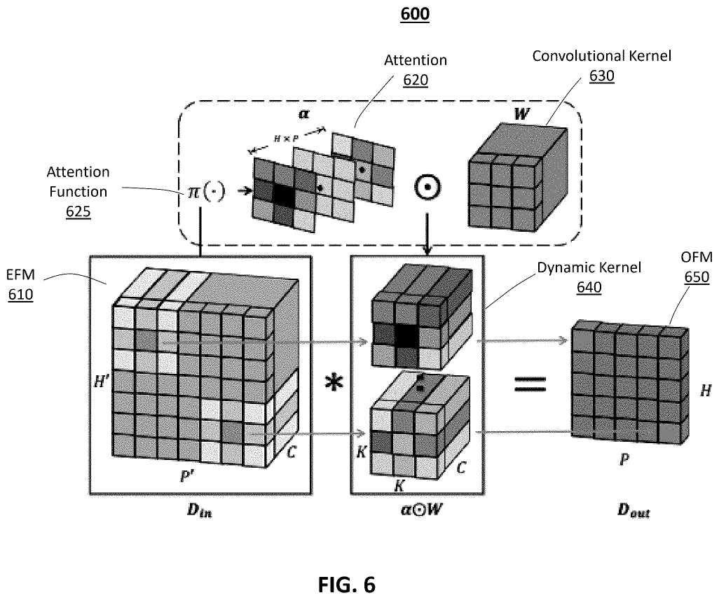

Parameters used by the attention module 230 to generate attentive kernels may be determined during a process that trains the PGConv layer 200. The parameters may include parameters for the pooling operation, operations of fully connected layers, activation functions, and batch normalization that are described above. The attentive kernels are dynamic as the values of the attentive weights can change if a different IFM is input into the PGConv layer 200. Even though a convolutional kernel may be static (e.g., because values of convolutional weights are determined through training the PGConv layer 200 and are independent from the IFM), a kernel generated by scaling a convolutional kernel with one or more attentive kernels can adopt the dynamic nature of the attentive kernel and therefore, can also be dynamic. More details regarding attentive kernels are described below in conjunction with FIG. 6.

The convolutional operator 240 performs convolutions based on IFMs (or EFMs), attentions, and convolutional kernels. For instance, the convolutional operator 240 can perform a convolution based on an EFM from the padding module 220, an attention generated based on the EFM by the attention module 230, and a convolutional kernel. A result of the dynamic convolution is an OFM. The convolutional kernel includes one or more convolutional filters. The number of convolutional filters in the convolutional kernel may equal to the channel size of the OFM. Each convolutional filter includes convolutional weights, values of which are determined by training the PGConv layer 200, e.g., training a DNN that includes the PGConv layer 200. An example of the convolutional kernel is the kernel 150 described above in conjunction with FIG. 1. The values of the convolutional weights are independent from the EFM and therefore, the convolutional kernel is static. In contrast, the attentive kernels in the attention are dynamic because the values of the attentive weight can change as the EFM changes. The convolutional operator 240 can scale the convolutional kernel with the attentive kernels and generate a scaled convolutional kernel. The scaled convolutional kernel adopts the dynamic nature of the attentive kernels and is also referred to as a dynamic kernel. The convolutional operator 240 can use the dynamic kernel and the EFM to perform a convolution, which is referred to as a dynamic convolution. The dynamic convolution can be denoted as:

$$\begin{matrix}{D}_{ij}^{out} = ( {α}_{ij} ⊙ W ) * {D}_{{δ}_{ij}}^{in} \\ {D}^{in} ∈ {R}^{H \times P \times {C}_{in}} \\ W ∈ {R}^{K \times K \times {C}_{in} \times {C}_{out}} \\ α ∈ {R}^{K \times K \times H \times P} \\ {α}_{ij} ∈ {R}^{K \times K}\end{matrix}$$

where αᵢⱼ denotes an attentive kernel of the attention α and is multiplied to a convolutional kernel W in an element-wise manner across channel dimensions, δᵢⱼ denotes a grid index vector of local patch centered on position (i, j) with i∈[1, H] and j∈[1, P].

In some embodiments, the convolutional operator 240 scales the convolutional kernel through element-wise multiplications on the convolutional kernel and the attentive kernels. In an example where the attention α includes three attentive kernels αₛ, α_{c}, and α_{f}. The element-wise multiplications may be denoted as:

$${W}^{…} = W ⊙ {α}_{s} ⊙ {α}_{c} ⊙ {α}_{f}$$

where [symbol] is the dynamic kernel. In some embodiments, the convolutional operator performs a sequence of scaling operations. Each scaling operation scales the convolutional kernel with an attentive kernel. In an example, the first scaling operation is formulated as:

$$\dot{W} = \{ {\dot{W}}^{i , j , k} \} = {W}^{i , j , k} \times {α}_{s}^{k} , for i = 1 … {C}_{out} , j = 1 … {C}_{in} , k = 1 … s$$

The second scaling operation is formulated as:

$$\ddot{W} = \{ {\ddot{W}}^{i , j , k} \} = {\dot{W}}^{i , j , k} \times {α}_{c}^{j} , for i = 1 … {C}_{out} , j = 1 … {C}_{in} , k = 1 … s$$

The second scaling operation is formulated as:

$$= \{ {{W}^{…}}^{i , j , k} \} = {\ddot{W}}^{i , j , k} \times {α}_{f}^{i} , for i = 1 … {C}_{out} , j = 1 … {C}_{in} , k = 1 … s$$

In other embodiments, the number or order of the scaling operations may be different.

After the dynamic kernel is generated, the convolutional operator 240 can perform a convolution based on the EFM and the dynamic kernel. In some embodiments, the convolutional operator 240 includes processing elements (PEs), which may be arranged in one or more arrays. The PEs can perform multiply-accumulate (MAC) operations on the dynamic kernel and the EFM. The weights in the dynamic kernel and the elements in the EFM can be distributed to the PEs, e.g., based on bitmaps. Each PE may have two input signals: a weight operand including weights from the dynamic kernel and an input operand including elements from the EFM. The PE can perform MAC operations on the weight operand and input operand and generates an output signal. The output signal may be provided to one or more other PEs for further processing. A result of the MAC operations of the PEs is the OFM. Even though some of the examples provide above refer to EFM, the convolutional operator 240 can perform dynamic convolutions on IFMs. Also, the convolutional operator 240 can perform conventional convolution, e.g., a convolution based on a convolutional kernel and an IFM or EFM.

### Example Point Grid Convolution

FIG. 3 illustrates an example point grid convolution 300, in accordance with various embodiments. The point grid convolution 300 is a convolution on grid-structured data. The point grid convolution 300 may include multiply-accumulate (MAC) operations on a grid IFM 320 and a kernel 350. A result of the MAC operations is a grid OFM 330. In some embodiments, the kernel 350 is a dynamic kernel generated based on a convolutional kernel and an attention, and the point grid convolution 300 may be a dynamic convolution. In other embodiments, the kernel 350 is a convolutional kernel, and the point grid convolution 300 may be a regular convolution, such as the convolution described above in conjunction with FIG. 1.

In the embodiments of FIG. 3, the grid IFM 320 is grid-structured data generated from a graph representation 310 of a person, e.g., through a sematic grid transformation by the transformation module 820 in FIG. 8. The grid IFM 320 may be a grid representation of the person and can include a plurality of input channels. Each channel may include an array including a number of rows and a number of columns. The kernel 350 includes a number of filters. The grid OFM 330 includes a plurality of output channels. The number of output channels in the grid OFM 330 may equal the number of filters in the kernel 350.

In some embodiments, the point grid convolution 300 may be formulated as

$${D}^{out} = W * {D}^{in}$$

where Dⁱⁿ∈R^{H×P×C}^{ᵢₙ} denotes the grid IFM 320 with a spatial size of H×P and Cᵢₙ channels, W∈R^{K×K×C}^{ᵢₙ}^{×C}^{ₒᵤₜ} denotes the kernel 350 having Cₒᵤₜ filters with a spatial size of K×K, e.g., K={1, 3, 5 . . . } based on spatial size of the grid IFM 320, and D^{out}∈R^{H×P×C}^{ₒᵤₜ} denotes the grid OFM 330 with a spatial size of H×P and Cₒᵤₜ channels.

The grid IFM 320 is transformed to an EFM 340 through padding. For purpose of simplicity and illustration, FIG. 3 shows one channel for the EFM 340. The number of channels in the EFM 340 may equal to the number of channels in the grid IFM 320. As shown in FIG. 3, the EFM 340 includes the input node elements 325 (individually referred to as “input node element 325”) in the grid IFM 320, such as all the input node elements 325 in the grid IFM 320, and additional node elements 345 (individually referred to as “additional node element 345”) that are not present in the grid IFM 320. The additional node elements 345 are placed on the four sides (i.e., top, bottom, left, and right) of the grid IFM 320, so that the EFM 340 has a larger spatial size (i.e., 7×7 as shown in FIG. 3) than the grid IFM 320 (i.e., 5×5 as shown in FIG. 3). In other embodiments, additional node elements 345 may be arranged on a subset of the four sides, as opposed to all the four sides. In an example, additional node elements 345 may be arranged on the top side but not on the bottom side, and/or on the left side but not on the right side. An additional node element 345 may have a value of zero or a non-zero value. In some embodiments, additional node elements 345 on a side may have values of the input node elements 325 on the other side. In an example (e.g., an example where circular padding is performed on the grid IFM 320), additional node elements 345 on the top of the EFM 340 have same values as the input node elements 325 on the bottom of the grid IFM 320. The number and order of the additional node elements 345 can also be the same as the number and order of the input node elements 325. As the additional node elements 345 and the input node elements 325 have the same values, they can be connected, which results in a 3D circular structure.

The point grid convolution 300 is performed on the EFM 340 and the kernel 350, which produces the grid OFM 330. In some embodiments, the kernel 350 is a dynamic kernel that includes weights determined based on the grid IFM 320, as indicated by the dash arrow in FIG. 3. The dynamic kernel may be generated through an element-wise multiplication of a convolutional kernel and an attention that is generated based on the EFM 340 or the grid IFM 320. In other embodiments, the kernel 350 is a convolutional kernel. The point grid convolution 300 may be performed by a PGConv layer (e.g., the PGConv layer 200). The PGConv layer may be a layer (e.g., the first layer) in a point grid network.

As shown in FIG. 3, the grid OFM 330 has the same spatial size (i.e., 5×5 as shown in FIG. 3) as the grid IFM 320 but smaller than the EFM 340. The grid OFM 330 may also be grid-structured data. The grid IFM 320 and the grid OFM 330 may have different numbers of channels. In other embodiments, the grid IFM 320 and the grid OFM 330 have different spatial sizes. The grid OFM 330 may be further processed, e.g., through an activation function, another convolution, or other functions.

### Example Semantic Grid Transformation

FIGS. 4A-4C illustrates an example semantic grid transformation, in accordance with various embodiments. The semantic grid transformation may be performed by the transformation module 820 in FIG. 8. FIG. 4A shows graph nodes identified from a graph representation of a person, such as the graph representation 310 in FIG. 3. Each graph node is shown as a circle of solid line in FIG. 4A and represents a different part of the person's body. For purpose of illustration, FIG. 4A shows 18 graph nodes representing the head, nose, chin, neck, right shoulder (“R. Shoulder” or “R. Shou.”), left shoulder (“L. Shoulder” or “L. Shou.”), right elbow (“R. Elbow”), torso, left elbow (“L. Elbow”), right wrist (“R. Wrist”), right hip (“R. Hip”), pelvis, left hip (“L. Hip”), left wrist (“L. Wrist”), right knee (“R. Knee”), left knee (“L. Knee”), right ankle (“R. Ankle”), and left ankle (“L. Ankle”). In other embodiments, more, fewer, or different graph nodes identified from the graph representation of the person.

The Torso graph node is used as the anchor node of the semantic grid transformation, e.g., based on a determination that the Torso graph node is connected to most of the other graph nodes and/or that the Torso graph node is at the center or close to the center of the graph representation of the person. As described above, a spatial relationship between the Torso graph node and each of the other graph nodes may be determined. The spatial relationship may be a vertical relationship (e.g., an ancestor-descendant relationship), a horizontal relationship (e.g., a peer relationship), or a combination of both. In some embodiments, the spatial relationship may be one or more distances from the Torso graph node to the other graph node, such as a linear distance from the Torso graph node to the other graph node, a horizontal distance along the X-axis (e.g., a distance from a projection of the Torso graph node on the X-axis to a projection of the other graph node on the X-axis), a distance along the Y-axis (e.g., a distance from a projection of the Torso graph node on the Y-axis to a projection of the other graph node on the Y-axis), etc.

Also, a hierarchy is determined based on the position of the other graph nodes relative to the Torso graph node. The hierarchy includes a sequence of tiers, each tier includes one or more graph nodes. The tiers are represented by dashed shapes (circles and ovals) in FIG. 4A. The first tier includes the Torso graph node and is represented by the smallest dashed shape that encloses the Torso graph node. The second tier includes the Neck graph node and Pelvis graph node and is represented by the second smallest dashed shape. Similarly, the third tier includes the R. Hip, R. Shoulder, Chin, L. Shoulder, and L. Hip graph nodes; the fourth tier includes the R. Knee, R. Elbow, Nose, L. Elbow, and L. Knee graph nodes, and the fifth tier includes the R. Ankle, R. Wrist, Head, L. Wrist, and L. Ankle graph nodes.

In FIG. 4B, a cone structure 410 is formed based on the hierarchy. The cone includes five layers, each layer corresponds to a tier of the hierarchy and the graph nodes in the tier are arranged in the corresponding layer of the cone. As shown in FIG. 4B, the Torso graph node is in the first/top layer, the graph nodes of the second tier are in the second layer, the graph nodes of the third tier are in the third layer, and so on. The arrangement of the graph nodes in the cone structure 410 of FIG. 4B reflects the relationships between the graph nodes shown in FIG. 4A. Even though FIG. 4B shows a cone structure 410, in other embodiments, the graph nodes can be arranged in different structures, such as cylinder, and so on.

In FIG. 4C, the graph nodes arranged in the cone structure 410 are “flattened” and a 2D grid representation 420 of the person is generated from the cone structure 410. The grid representation 420 has a grid structure including five rows and five columns, i.e., 25 elements in total. The number of rows equals the number of tiers in the hierarchy. The number of columns equals the number of graph nodes in the tier that has the most graph nodes, i.e., the fifth tier. Each graph nodes are in one of the 25 elements. The graph nodes in the same tier are in the same row. The Torso graph node is in the middle element of the first row. The grid representation 420 may be an embodiment of the grid IFM 320 in FIG. 3. The grid representation 420 includes empty grid elements, e.g., in the first row and the second row. An empty grid element may be filled with a graph node in the same row. For instance, some or all of the four empty elements in the first row may be filled with the Torso graph node. The semantic grid transformation shown in FIGS. 4A-4C may be defined as

D=Ø(G)

where Ø denotes the transformation function for mapping node indices, G∈R^{j×C} denotes the input graph sample (i.e., the graph representation) having/nodes and each node has C feature channels, and D∈R^{H×P×C} denotes the output of a weave-like grid (e.g., the grid representation 420) with a spatial size of H×P. The weave-like grid may have a rectangular shape or square shape, depending on the values of H and P. Even though the semantic grid transformation includes the formation of the cone structure 410 in FIG. 4B, the grid representation 420 may be generated directly from the graphical representation of the person in other embodiments, and the step shown in FIG. 4B may be skipped.

### Example Padding

FIGS. 5A-5D illustrates various padding methods, in accordance with various embodiments. The padding illustrated in FIGS. 5A-5D may be performed on a grid representation that is converted from a graph representation through semantic grid transformation. Given a graph-structured data representation, a data sample can be represented as a graph G={V, E} with the nodes V storing node features and the edges defining node connections. The degree of the graph nodes depends on the connected edges E, which leads to irregular neighborhoods of local regions. In some situations, the original graph representation may have a limited number of nodes, e.g., a 2D huma pose with N=17 body joints. That can cause that the grid representation will have a small spatial size, such as 5×5, or 7×5. Thus, it can be important to perform padding on grid-structured data samples.

The padding illustrated in FIGS. 5A-5D may be performed on the grid representation 420 in FIG. 4. For purpose of illustration, FIGS. 5A-5D shows four EFMs 510, 520, 530, and 540 that are generated based on four different padding methods. In other embodiments, other padding methods can be used, or EFMs of other shapes can be formed.

FIG. 5A shows the EFM 510 that is transformed from the grid representation 420 through zero padding. The zero padding puts additional node elements having values of zero to some or all of the four edges of the grid representation 420. Similar to the grid representation 420, the EFM 510 also has a two-dimensional grid pattern, like a tablet pattern. The spatial scale of the EFM 510 is larger than that of the grid representation 420. The EFM 510 may be an embodiment of the EFM 340 in FIG. 3.

FIG. 5B shows the EFM 520 that is transformed from the grid representation 420 through circular padding. The circular padding in FIG. 5B puts additional node elements on the four edges of the grid representation 420. Difference from the zero padding in FIG. 5A, the values of the additional node elements in FIG. 5B is determined based on values of node elements in the grid representation 420. For example, the additional node elements on the top (or bottom) edge have same values as the node elements at the bottom (or top) of the grid representation 420, and the additional node elements on the right (or left) edge have same values as the node elements on the left (or right) of the grid representation 420. The circular padding can connect the top edge to the bottom edge and connect the right edge to the left edge, which results in the 3D torus grid pattern shown in FIG. 5A. The EFM 520 has a donut shape.

FIG. 5C shows the EFM 530 that is transformed from the grid representation 420 through a combination of circular padding and zero padding. The circular padding in FIG. 5C puts additional node elements on the right (or left) edge of the grid representation 420, and the additional node elements on the right (or left) edge have same values as the node elements on the left (or right) of the grid representation 420. The circular padding can connect the right edge to the left edge. The zero padding puts zero-valued additional node elements on the top or bottom edge and does not connect the top edge and bottom edge. Thus, the combination of circular padding and zero padding results in a hollow cylindrical grid pattern, which looks like a bucket.

FIG. 5D shows the EFM 540 that is transformed from the grid representation 420 through a combination of circular padding and zero padding. The circular padding in FIG. 5D puts additional node elements on the top (or bottom) edge of the grid representation 420, and the additional node elements have same values as the node elements on the bottom (or top) of the grid representation 420. The circular padding can connect the top edge with the bottom edge. The zero padding puts zero-valued additional node elements on the right or left edge and does not connect the right edge and left edge. Thus, the combination of circular padding and zero padding results in a hollow cylindrical grid pattern, which looks like a pipe.

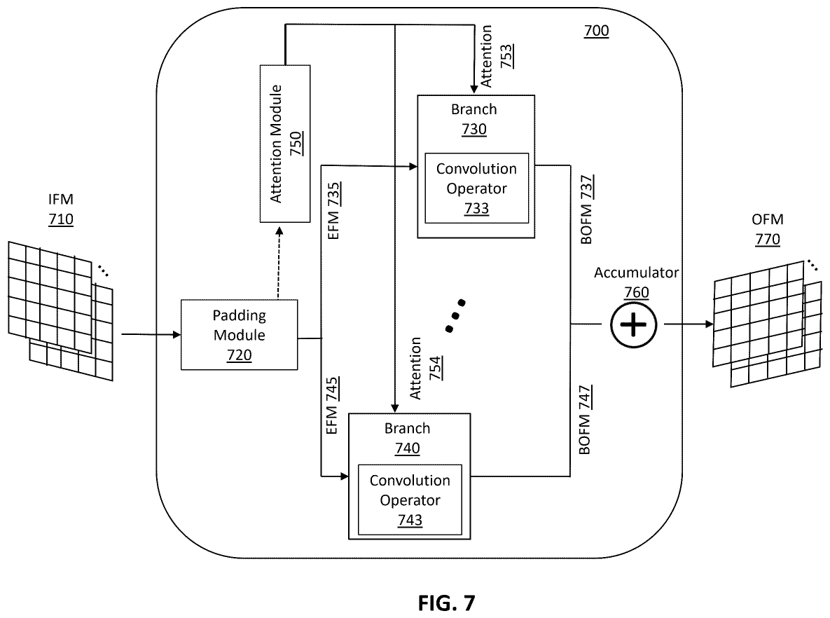

Each of these four padding designs can preserve the spatial size of the grid representation 420, e.g., the OFM generated from the grid representation 420 can have the same spatial size as the grid representation 420. Also, the padding designs can keep convolution operations consistent between inner node elements and boundary node elements. Additionally, the diverse connection states on horizontal and vertical boundaries make the convolutions on one grid pattern complementary to convolutions on other grid patterns. With multiple padding methods, powerful PGConv-driven architectures can be built to handle different applications, such as the applications mentioned above. The padding methods can be used with other techniques, such as dynamic convolution. For instance, dynamic kernels can be generated based on EFMs that are formed from an IFM through various padding methods. This paves a technical way to design powerful PGConv-based networks via novel multi-branch building blocks. More information regarding multi-branch design of PGConv layers are provided below in conjunction with FIG. 7.

### Example Dynamic Convolution

FIG. 6 illustrates an example dynamic convolution 600, in accordance with various embodiments. The dynamic convolution 600 may be performed by the convolution operator 240 in FIG. 2. The dynamic convolution 600 is a convolution performed on an EFM 610 and a dynamic kernel 640. In other embodiments, the dynamic convolution 600 may be performed on an IFM and the dynamic kernel 640. The EFM 610 may be denoted as Dⁱⁿ∈R^{H×P′×C}, where C is the number of channels in the EFM 610, and H′×P′ is the spatial size of the EFM 610, i.e., the number of node elements for every channel is H′×P′, where H′ is the number of rows and P′ is the number of columns.

The dynamic kernel 640 is generated based on an attention 620 (a) and a convolutional kernel 630 (W∈R^{K×K×C}). In some embodiments, the dynamic kernel 640 may be a result of element-wise multiplications of the attentive kernel α and the convolutional kernel W. The dynamic kernel 640 may be denoted as α⊙W. The attention 620 is generated based on the EFM 610 by using an attention function 625 (π(⋅)). In the embodiments of FIG. 6, the attention function 625 outputs α∈^{R×K×H×P}. The attention function 625 can determine αₛ∈R^{K×K×1×1} for every node element in a channel of the EFM 610. As the EFM 610 has H×P number of node elements in a single channel, the overall attention can be denoted as α∈R^{K×K×H×P}. The attentive kernel has dimensions of the convolutional weight (K×K) and dimensions of the EFM 610 (H′×P′).

The dynamic convolution produces an OFM 650 (D^{out}∈R^{H×P}). The OFM 650 may have the same spatial size of an OFM from which the EFM 610 is generated through padding. For purpose of simplicity and illustration, the convolutional kernel 630 includes one filter, and the OFM 650 includes one output channel. In other embodiments, the convolutional kernel 630 may include multiple filters, and the OFM 650 may include multiple output channels.

Example PGConv Layer with Multi-Branch Design

FIG. 7 illustrates an example PGConv layer 700 including multiple branches 730 and 730, in accordance with various embodiments. The PGConv layer 700 may be an embodiment of a PGConv layer 200 in FIG. 2. As shown in FIG. 7, the PGConv layer 700 receives a IFM 710 and output a OFM 770. An example of the IFM 710 is the grid IFM 320 in FIG. 3 or the grid representation 420 in FIG. 4C. For purpose of simplicity and illustration, FIG. 7 shows two branches 730 and 740. In other embodiments, the PGConv layer 700 may include more branches. In the embodiments of FIG. 7, each branch performs a dynamic convolution. In addition to the branches 730 and 730, the PGConv layer 700 also includes a padding module 720, an attention module 750, and an accumulator 760. In other embodiments, alternative configurations, different or additional components may be included in the PGConv layer 700. Further, functionality attributed to a component of the PGConv layer 700 may be accomplished by a different component included in the PGConv layer 700 or by a different system.

The padding module 720 applies padding on the IFM 710. An embodiment of the padding module 720 is the padding module 220 in FIG. 2. In the embodiments of FIG. 7, the padding module 720 generates EFMs 735 and 745 based on the IFM 710, e.g., by using different padding methods. The EFMs 735 and 745 may have different grid patterns. In some embodiments, the EFM 735 or 745 may have a grid pattern of one of the EFMs 510, 520, 530, 540 shown in FIGS. 5A-5D. The padding module 720 provides the EFM 735 to the branch 730 and provides the EFM 745 to the branch 740. The padding module 720 also provides the EFMs 735 and 745 to the attention module 750.

The attention module 750 receives the EFMs 735 and 745 and generates attentions 7543 and 754 based on the EFMs 735 and 745, respectively. Each attention includes one or more attentive kernels including attentive weights determined based on the corresponding EFM. The attentions 753 and 754 may be different, e.g., due to the difference between the EFMs 735 and 745. The attention module 750 provides the attention 753 to the branch 730 and provides the attention 754 to the branch 740. The attention module 750 may be an embodiment of the attention module 230 in FIG. 2.

The branch 730 includes a convolutional operator 733. The convolutional operator 733 can perform a dynamic convolution based on the EFM 735, the attention 753, and a convolutional kernel that is determined from the training of the PGConv layer 700. The result of the convolution is a branch OFM (BOFM) 737. Similarly, the branch 740 includes a convolutional operator 743. The convolutional operator 743 can perform a dynamic convolution based on the EFM 745, the attention 754, and a convolutional kernel that is determined from the training of the PGConv layer 700. The result of the convolution is a BOFM 747. The BOFM 737 may be different from the BOFM 747 given the difference between the EFMs 735 and 745, between the attentions 753 and 754, between the two convolutional kernels, or some combination thereof. In some embodiments, the convolutional kernels in the two branches 730 and 740 may be the same.

The BOFMs 737 and 747 are provided to the accumulator 760. The accumulator 760 aggregates the BOFMs 737 and 747 and produces the OFM 770. In some embodiments, the accumulator 760 sums up the BOFMs 737 and 747. For instance, the accumulator 760 may perform element-wise summation of the BOFMs 737 and 747. The element-wise summation may include element by element summations for every channel. An example element by element summation may be a summation of an element in the BOFM 737 and a corresponding element in the BOFM 747. The spatial coordinate of the two elements match. For example, the two elements may both be in the first row and first column of the first channel of the corresponding BOFM. The resulting OFM 770 may have the same spatial size and channel dimension (i.e., the number of channels) as the BOFMs 737 and 747. The OFM 770 may have the same spatial size as the IFM 710, but may have a different channel dimension from the IFM 710. The channel dimension of the OFM 770 depends on the number of filters in the dynamic kernel.

### Example Point Grid System

FIG. 8 is a block diagram of a point grid system 800, in accordance with various embodiments. The point grid system 800 facilitates convolutions on grid-structured data generated from semantic grid transformation of graph-structured data. The point grid system 800 includes an interface module 810, a transformation module 820, a training module 830, a validation module 840, a point grid model 850, and an inverse transformation module 860. In other embodiments, alternative configurations, different or additional components may be included in the point grid system 800. For instance, the point grid system 800 may include more than one point grid model. Further, functionality attributed to a component of the point grid system 800 may be accomplished by a different component included in the point grid system 800 or by a different system. For instance, some or all functionality attributed to the transformation module 820 or the inverse transformation module 860 may be accomplished by the point grid model 850.

The interface module 810 facilitates communications of the point grid system 800 with other systems. In some embodiments, the interface module 810 establishes communications between the point grid system 800 with an external database to receive graph-structured data that can be used to generate grid-structured data for training the point grid model 850 or for inference of the point grid model 850. The external database may be an image gallery that stores a plurality of images, such as 8D images, 3D images, etc. The interface module 810 may support the point grid system 800 to distribute the point grid model 850 to other systems, e.g., computing devices configured to apply the point grid model 850 to perform tasks. The computing devices may be an edge device, a client device, and so on. The interface module 810 may also support the point grid system 800 to distribute output of the inverse transformation module 860 to other systems.

The transformation module 820 performs semantic grid transformation on graphic-structured data samples. The transformation module 820 may receive the graphic-structured data samples from the interface module 810. A graph-structured data sample may be a graphical representation of one or more objects, e.g., an image of the one or more objects. An object may be a person, animal, plant, tree, building, vehicle, street, or other types of objects. Graphical representations can have irregular structures. For instance, a graphical representation of a person has contours of the person's body, which can be different from the graphical representation of another person, or even another graphical representation of the same person having a different pose. The transformation module 820 can transform graphical representations having irregular structures into grid representations having regular structures.

In some embodiments, the transformation module 820 transforms a graphical representation of an object to a grid representation of the object based on a grid pattern. The grid pattern has a regular structure, which can be adopted by the grid representation through the semantic grid transformation. The structure of the grid pattern may be fixed and can either be 2D or 3D. An example grid pattern includes a number of elements, each of which is defined by fixed boundaries. The elements may be arranged in rows and/or columns. For instance, a row or column may have one or more elements. The transformation module 820 may obtain (e.g., generate or retrieve from a database) grids with different structures. The transformation module 820 can select a grid based on the graph-structured data sample, e.g., based on a class of an object illustrated in the graph-structured data sample. For instance, the transformation module 820 may uses a different grid to transform a graphical representation of a person than a graphical representation of a tree.

In a semantic grid transformation of a graphical representation of an object, the transformation module 820 may identify graph nodes in the graphical representation. A graph node is a graphical representation of one or mor component of the object. In an example where the object is a person, the transformation module 820 may identify graph nodes that respectively represents different parts of the person's body, such as head, neck, torso, arms, legs, and so on. The transformation module 820 may identify the graph nodes based on body joints illustrated in the graphical representation of the person. The transformation module 820 may assign the graph nodes into different elements of the grid to form a grid representation of the object. The grid representation adopts both information from the graphical representation (e.g., the relationships between the graph nodes) and the regular structure of the grid pattern.

In some embodiments, the transformation module 820 identifies an anchor node from the graph nodes and assigns the anchor node first. The transformation module 820 may select the anchor node randomly. Alternatively, the transformation module 820 may select the anchor node based on a rule. In an embodiment, the transformation module 820 may select the graph node that is connected to some or all the other graph node as the anchor node. For instance, the transformation module 820 may select the graph node representing the torso of a person as the anchor node of the person's graphical representation, or select the graph node representing the central trunk of a tree as the anchor node of the tree's graphical representation. In another embodiment, the anchor node may be a root node. After the anchor node is determined, the transformation module 820 assigns the anchor node to an element of the grid. The element may be pre-determined. In an example, the transformation module 820 assigns the anchor node to a particular row (or a particular element in the particular row) of the grid.

The transformation module 820 further assigns the other graph nodes (“secondary nodes”) based on the assignment of the anchor node. The transformation module 820 may determine a relationship between a secondary node and the anchor node and assigns the secondary node based on the relationship. The relationship may be a spatial relationship, such as a distance from the component represented by the secondary node to the component represented by the anchor node. The transformation module 820 may measure the distance based on the graphical representation of the object. The spatial relationship may be multi-dimensional. For instance, the transformation module 820 may determine a vertical node relationship (which may indicate a distance, orientation, or both between the two components along a first direction) and a horizontal node relationship (which may indicate a distance, orientation, or both between the two components along a second direction that is perpendicular or substantially perpendicular to the first direction).

The transformation module 820 assigns the secondary node based on its relationship with the anchor node. For instance, the transformation module 820 selects an element of the grid for the secondary node based on the relationship and the pre-determined element where the anchor node is assigned. The spatial relationship between the two elements may match the spatial relationship between the secondary node and the anchor node. In an example where the secondary node is below the anchor node in the graphical representation, the transformation module 820 assigns the secondary node to an element that is below the pre-determined element in the grid. In another example where the secondary node is at the left of the anchor node in the graphical representation, the transformation module 820 assigns the secondary node to an element that is at the left of the pre-determined element in the grid.

In some embodiments, the transformation module 820 may determine a hierarchy of the graph nodes, where the anchor node is the first tier, one or more secondary nodes that are closest to the anchor node is the second tier, one or more secondary nodes that are second closest to the anchor node is the third tier, and so on. In an example where the anchor node is assigned to the first row of the grid, the secondary nodes in the second tier are assigned to the second row, the secondary nodes in the third tier are assigned to the third row, and so on. The transformation module 820 may determine the hierarchy based on spatial relationships in one dimension. The transformation module 820 may further determine additional spatial relationships, which are in a different dimension, between secondary nodes in the same tier and assigns secondary nodes to different elements in the same row based on the additional spatial relationships.

The training module 830 trains the point grid model 850, which performs machine learning tasks with grid-structured data samples. In a process of training the point grid model 850, the training module 830 may form a training dataset. The training dataset includes training samples and ground-truth labels. The training samples may be grid-structured data samples provided by the transformation module 820. Each training samples may be associated with one or more ground-truth labels. A ground-truth label of a training sample may be a known or verified label that answers the problem or question that the point grid model 850 will be used to answer. In an example where the point grid model 850 is used to estimate pose, a ground-truth label may indicate a ground-truth pose of an object in the training sample. The ground-truth label may be a numerical value that indicates a pose or a likelihood of the object having a pose. In some embodiments, the training module 830 may also form validation datasets for validating performance of trained DNNs by the validation module 840. A validation dataset may include validation samples and ground-truth labels of the validation samples. The validation dataset may include different samples from the training dataset used for training the point grid model 850. In an embodiment, a part of a training dataset may be used to initially train the point grid model 850, and the rest of the training dataset may be held back as a validation subset used by the validation module 840 to validate performance of the point grid model 850. The portion of the training dataset not including the validation subset may be used to train the point grid model 850.

The training module 830 also determines hyperparameters for training the point grid model 850. Hyperparameters are variables specifying the training process. Hyperparameters are different from parameters inside the point grid model 850 (“internal parameters,” e.g., weights in a convolutional kernel of a PGConv layer). In some embodiments, hyperparameters include variables determining the architecture of the point grid model 850, such as number of hidden layers, etc. Hyperparameters also include variables which determine how the point grid model 850 is trained, such as batch size, number of epochs, etc. A batch size defines the number of training samples to work through before updating the parameters of the point grid model 850. The batch size is the same as or smaller than the number of samples in the training dataset. The training dataset can be divided into one or more batches. The number of epochs defines how many times the entire training dataset is passed forward and backwards through the entire network. The number of epochs defines the number of times that the DL algorithm works through the entire training dataset. One epoch means that each training sample in the training dataset has had an opportunity to update the internal parameters of the point grid model 850. An epoch may include one or more batches. The number of epochs may be 15, 150, 500, 1500, or even larger.

The training module 830 defines the architecture of the point grid model 850, e.g., based on some of the hyperparameters. The architecture of the point grid model 850 includes an input layer, an output layer, and a plurality of hidden layers. The input layer of the point grid model 850 may include tensors (e.g., a multi-dimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the point grid model 850 convert the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different category by training.

In the process of defining the architecture of the point grid model 850, the training module 830 also adds an activation function to a hidden layer or the output layer. An activation function of a layer transforms the weighted sum of the input of the layer to an output of the layer. The activation function may be, for example, a ReLU activation function, a tangent activation function, or other types of activation functions. After the training module 830 defines the architecture of the point grid model 850, the training module 830 inputs the training dataset into the point grid model 850. The training module 830 modifies the internal parameters of the point grid model 850 to minimize the error between labels of the training samples that are generated by the point grid model 850 and the ground-truth labels. In some embodiments, the training module 830 uses a cost function or loss function to minimize the error.

The training module 830 may train the point grid model 850 for a pre-determined number of epochs. The number of epochs is a hyperparameter that defines the number of times that the DL algorithm will work through the entire training dataset. One epoch means that each sample in the training dataset has had an opportunity to update the internal parameters of the point grid model 850. After the training module 830 finishes the pre-determined number of epochs, the training module 830 may stop updating the internal parameters of the point grid model 850, and the point grid model 850 is considered trained.

The validation module 840 verifies accuracy of the point grid model 850 after the point grid model 850 is trained. In some embodiments, the validation module 840 inputs samples in a validation dataset into the point grid model 850 and uses the outputs of the point grid model 850 to determine the model accuracy. In some embodiments, a validation dataset may be formed of some or all the samples in the training dataset. Additionally or alternatively, the validation dataset includes additional samples, other than those in the training sets. In some embodiments, the validation module 840 determines may determine an accuracy score measuring the precision, recall, or a combination of precision and recall of the DNN. The validation module 840 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=8*PR/(P+R)) unifies precision and recall into a single measure.

The validation module 840 may compare the accuracy score with a threshold score. In an example where the validation module 840 determines that the accuracy score is lower than the threshold score, the validation module 840 instructs the training module 830 to re-train the point grid model 850. In one embodiment, the training module 830 may iteratively re-train the point grid model 850 until the occurrence of a stopping condition, such as the accuracy measurement indication that the point grid model 850 may be sufficiently accurate, or a number of training rounds having taken place.

The point grid model 850 performs machine learning tasks with grid-structured data. A machine learning task is a task of making an inference. The inference is a process of running available data (e.g., grid-structured data) into the point grid model 850 to generate an output. The output provides a solution to a problem or question that is being asked. The point grid model 850 can perform machine learning tasks for various applications, including applications that conventionally rely on graph-structured data, such as 2D-to-3D human pose lifting, skeleton based human action recognition, 3D mesh reconstruction, traffic navigation, social network analysis, recommend system, and scientific computing. In some embodiments, the point grid model 850 is a convolutional network that includes a plurality of hidden layers, e.g., one or more convolutional layers. The point grid model 850 may include one or more PGConv layers, such as the PGConv layer 200 or 700. An embodiment of the point grid model 850 may be the CNN 100 described above in conjunction with FIG. 1.

In some embodiments, the point grid model 850 receives a grid-structured data sample from the transformation module 820 and processes the grid-structured data sample to make a determination. A convolutional layer of the point grid model 850 may extract features from the grid-structured data sample or from an output of another layer of the point grid model 850. In an embodiment, the convolutional layer may generate variants of the grid-structured data sample and extracts features based on the variants. A variant of the grid-structured data sample may include some or all of the graph nodes in the grid-structured data sample but has a different structure from the grid-structured data sample or the other variants. The output of the point grid model 850 may be grid-structured data, such as a grid-structured feature map. More details regarding the point grid model 850 are provided below in conjunction with FIGS. 3 and 5-7.

The inverse transformation module 860 can transform grid-structured outputs of the point grid model 850 to graph-structured data. In an example, the point grid model 850 outputs a grid representation of an estimated pose of an object and sends the output to the inverse transformation module 860. The inverse transformation module 860 converts the grid representation to a graphical representation of the estimated pose, e.g., through a transformation that is an inverse of sematic grid transformation. Such a transformation is referred to as a semantic graph transformation. The semantic graph transformation may be necessary in certain applications where another system or a user needs graph-structured data as opposed to grid-structured data. The graphical representation generated by the inverse transformation module 860 may be a 3D graph that shows the estimated pose. In some embodiments, the inverse transformation module 860 may generate a 3D image or animation showing the estimated pose.

### Example 3D Pose Estimation

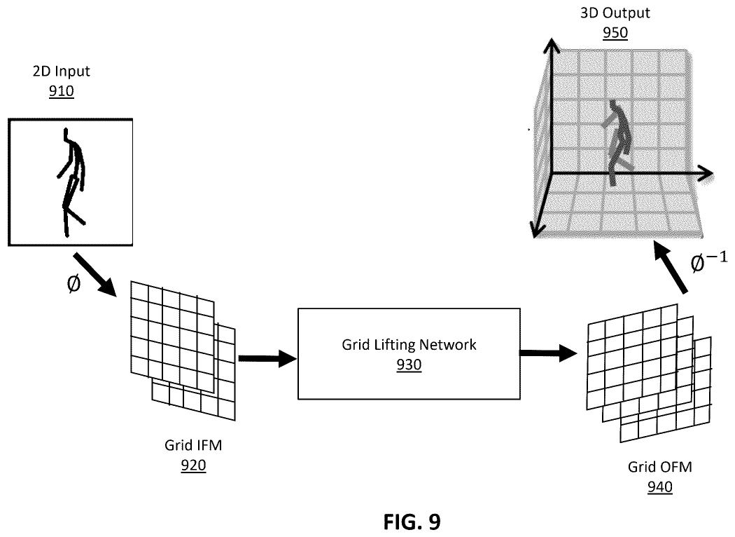

FIG. 9 illustrates an example 3D pose estimation based on a 2D input 910, in accordance with various embodiments. The 2D input 910 is a graphical representation of a person, which may show a 2D pose of the person. As shown in FIG. 9, the 2D input 910 is converted to a grid IFM 920, e.g., through a semantic grid transformation, Ø. The semantic grid transformation may be done by the transformation module 820 in FIG. 8. In some embodiments, the grid IFM 920 is a result of padding that is applied on a grid representation of the 2D input 910.

As shown in FIG. 9, the grid IFM 920 is input into a grid lifting network 930. The grid lifting network 930 may include one or more PGConv layers, such as the PGConv layer 200 or 700. The grid lifting network 930 may be an embodiment of the point grid model 850 in FIG. 8. The grid lifting network 930 has been trained to process grid-structured data samples, e.g., through point grid convolutions, to estimate 3D pose. The grid lifting network 930 may be trained with a training dataset that includes grid-structured data samples and ground-truth grid pose of the samples. In some embodiments, the grid lifting network 930 may be trained by minimizing an error L between the predicted 3D grid pose D_{3D} and the ground-truth DGT 30 over the training dataset:

$$L = {‖ {D}_{3 D} - {D}_{3 D}^{GT} ‖}^{2}$$

where L denotes a 2-norm distance.

After the training, the grid lifting network 930 can estimate 3D pose through inferences. An inference is a process of processing an input, such as the grid IFM 920, and generates an output, such as the grid OFM 940, which indicates a 3D pose. In some embodiments, the spatial size of the grid IFM 920 and the spatial size of the grid OFM 940 are the same, but the number of channels may be different. For instance, the grid IFM 920 may have two channels representing 2D joint locations, versus the grid OFM 940 may have three channels representing 3D joint locations. In other embodiments (e.g., embodiments that uses a dense 2D pose input to estimate a sparse 3D pose and one or more 3D joint locations are estimated from all 2D joint locations), the spatial size of the grid IFM 920 and the spatial size of the grid OFM 940 may be different.

The grid OFM 940 is then converted to a 3D output 950 through an inverse transformation Ø⁻¹. The inverse transformation may be done by the inverse transformation module 260 in FIG. 2. The 3D output 950 is a 3D graph representation of the estimated pose. In some embodiments, if a particular Ø is defined, an inverse transformation Ø⁻¹ that converts D back to G can be easily obtained by mapping grids back into/unique nodes. For repetitive grids, feature merging is applied in the inverse transformation.

As shown in FIG. 9, the lifting process includes the semantic grid transformation (Ø⁻¹), the inference of the grid lifting network 930, and the inverse transformation (Ø). The lifting process may be represented by:

$${G}_{3 D} = {∅}^{- 1} ( F ( ∅ ( {G}_{2 D} ) ) )$$

where G_{3D} represents the 3D output 950, F denotes the inference of the grid lifting network 930, and G_{2D} denotes the 2D input 910.

### Example DL Environment

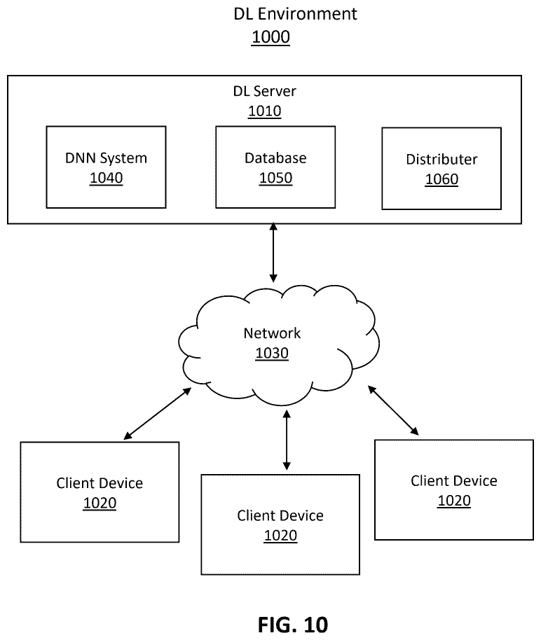

FIG. 10 illustrates a DL environment 1000, in accordance with various embodiments. The DL environment 1000 includes a DL server 1010 and a plurality of client devices 1020 (individually referred to as client device 1020). The DL server 1010 is connected to the client devices 1020 through a network 1030. In other embodiments, the DL environment 1000 may include fewer, more, or different components.

The DL server 1010 trains DL models using neural networks. A neural network is structured like the human brain and consists of artificial neurons, also known as nodes. These nodes are stacked next to each other in three types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The DL server 1010 can use various types of neural networks, such as DNN, recurrent neural network (RNN), generative adversarial network (GAN), long short-term memory network (LSTMN), and so on. During the process of training the DL models, the neural networks use unknown elements in the input distribution to extract features, group objects, and discover useful data patterns. The DL models can be used to solve various problems, e.g., making predictions, classifying images, and so on. The DL server 1010 may build DL models specific to particular types of problems that need to be solved. A DL model is trained to receive an input and outputs the solution to the particular problem.

In FIG. 10, the DL server 1010 includes a DNN system 1040, a database 1050, and a distributer 1060. The DNN system 1040 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the CNN 100 described above in conjunction with FIG. 1, the grid lifting network 930 in FIG. 9, or the point grid model 850 described above in conjunction with FIG. 8. An embodiment of the DNN system 1040 is the point grid system 800 described above in conjunction with FIG. 9.

The database 1050 stores data received, used, generated, or otherwise associated with the DL server 1010. For example, the database 1050 stores a training dataset that the DNN system 1040 uses to train DNNs. In an embodiment, the training dataset is an image gallery that can be used to train a DNN for classifying images, estimating poses, and so on. The training dataset may include data received from the client devices 1020. As another example, the database 1050 stores hyperparameters of the neural networks built by the DL server 1010.

The distributer 1060 distributes DL models generated by the DL server 1010 to the client devices 1020. In some embodiments, the distributer 1060 receives a request for a DNN from a client device 1020 through the network 1030. The request may include a description of a problem that the client device 1020 needs to solve. The request may also include information of the client device 1020, such as information describing available computing resource on the client device. The information describing available computing resource on the client device 1020 can be information indicating network bandwidth, information indicating available memory size, information indicating processing power of the client device 1020, and so on. In an embodiment, the distributer may instruct the DNN system 1040 to generate a DNN in accordance with the request. The DNN system 1040 may generate a DNN based on the information in the request. For instance, the DNN system 1040 can determine the structure of the DNN and/or train the DNN in accordance with the request.

In another embodiment, the distributer 1060 may select the DNN from a group of pre-existing DNNs based on the request. The distributer 1060 may select a DNN for a particular client device 1020 based on the size of the DNN and available resources of the client device 1020. In embodiments where the distributer 1060 determines that the client device 1020 has limited memory or processing power, the distributer 1060 may select a compressed DNN for the client device 1020, as opposed to an uncompressed DNN that has a larger size. The distributer 1060 then transmits the DNN generated or selected for the client device 1020 to the client device 1020.

In some embodiments, the distributer 1060 may receive feedback from the client device 1020. For example, the distributer 1060 receives new training data from the client device 1020 and may send the new training data to the DNN system 1040 for further training the DNN. As another example, the feedback includes an update of the available computer resource on the client device 1020. The distributer 1060 may send a different DNN to the client device 1020 based on the update. For instance, after receiving the feedback indicating that the computing resources of the client device 1020 have been reduced, the distributer 1060 sends a DNN of a smaller size to the client device 1020.

The client devices 1020 receive DNNs from the distributer 1060 and applies the DNNs to perform machine learning tasks, e.g., to solve problems or answer questions. In various embodiments, the client devices 1020 input images into the DNNs and uses the output of the DNNs for various applications, e.g., visual reconstruction, augmented reality, robot localization and navigation, medical diagnosis, weather prediction, and so on. A client device 1020 may be one or more computing devices capable of receiving user input as well as transmitting and/or receiving data via the network 1030. In one embodiment, a client device 1020 is a conventional computer system, such as a desktop or a laptop computer. Alternatively, a client device 1020 may be a device having computer functionality, such as a personal digital assistant (PDA), a mobile telephone, a smartphone, an autonomous vehicle, or another suitable device. A client device 1020 is configured to communicate via the network 1030. In one embodiment, a client device 1020 executes an application allowing a user of the client device 1020 to interact with the DL server 1010 (e.g., the distributer 1060 of the DL server 1010). The client device 1020 may request DNNs or send feedback to the distributer 1060 through the application. For example, a client device 1020 executes a browser application to enable interaction between the client device 1020 and the DL server 1010 via the network 1030. In another embodiment, a client device 1020 interacts with the DL server 1010 through an application programming interface (API) running on a native operating system of the client device 1020, such as IOS® or ANDROID™.

In an embodiment, a client device 1020 is an integrated computing device that operates as a standalone network-enabled device. For example, the client device 1020 includes display, speakers, microphone, camera, and input device. In another embodiment, a client device 1020 is a computing device for coupling to an external media device such as a television or other external display and/or audio output system. In this embodiment, the client device 1020 may couple to the external media device via a wireless interface or wired interface (e.g., an HDMI cable) and may utilize various functions of the external media device such as its display, speakers, microphone, camera, and input devices. Here, the client device 1020 may be configured to be compatible with a generic external media device that does not have specialized software, firmware, or hardware specifically for interacting with the client device 1020.

The network 1030 supports communications between the DL server 1010 and client devices 1020. The network 1030 may comprise any combination of local area and/or wide area networks, using both wired and/or wireless communication systems. In one embodiment, the network 1030 may use standard communications technologies and/or protocols. For example, the network 1030 may include communication links using technologies such as Ethernet, 10010.11, worldwide interoperability for microwave access (WiMAX), 3G, 4G, code division multiple access (CDMA), digital subscriber line (DSL), etc. Examples of networking protocols used for communicating via the network 1030 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 1030 may be represented using any suitable format, such as hypertext markup language (HTML) or extensible markup language (XML). In some embodiments, all or some of the communication links of the network 1030 may be encrypted using any suitable technique or techniques.

### Example Method of Point Grid Convolution Facilitated by Padding

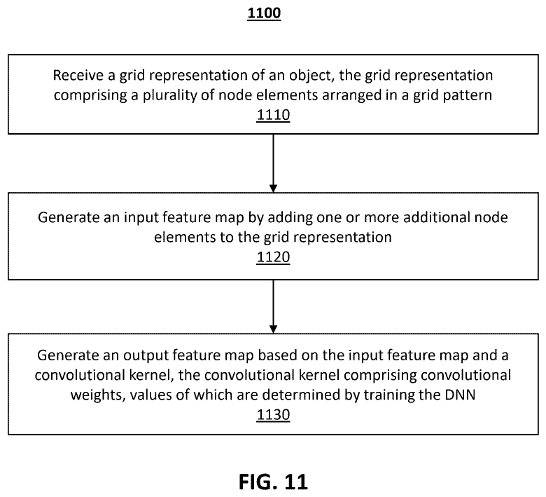

FIG. 11 is a flowchart showing a method 1100 of point grid convolution facilitated by padding, in accordance with various embodiments. The method 1100 may be performed by the PGConv layer 200 in FIG. 2. Although the method 1100 is described with reference to the flowchart illustrated in FIG. 11, many other methods for point grid convolution facilitated by padding may alternatively be used. For example, the order of execution of the steps in FIG. 11 may be changed. As another example, some of the steps may be changed, eliminated, or combined.

The PGConv layer 200 receives 1110 an IFM. The IFM includes a grid representation of an object. The grid representation comprises a plurality of node elements arranged in a grid pattern. The grid pattern may have a 2D grid pattern that includes a plurality of edges.

The PGConv layer 200 generates 1120 an EFM by adding one or more additional node elements to the grid representation. The EFM includes the plurality of node elements and the one or more additional node elements. The plurality of node elements and the one or more additional node elements may be arranged in a grid pattern that is different from the grid pattern of the IFM. The grid pattern of the EFM may be 3D, and the grid pattern of the IFM may be 2D. The PGConv layer 200 may adding the one or more additional node elements on one or more edges of the grid pattern of the IFM. In some embodiments, an additional node element of the one or more additional node elements has a value of zero. In other embodiments, an additional node element of the one or more additional node elements has a value of a node element of the plurality of node elements. In an example, the grid pattern has a 2D grid pattern including a first edge and a second edge opposite the first edge. The node element is arranged on the first edge, and the additional node element may be added on the second edge.

The PGConv layer 200 generates 1130 an OFM based on the EFM and a convolutional kernel. The convolutional kernel includes convolutional weights, values of which are determined by training the DNN. In some embodiments, the EFM is a first EFM, and the PGConv layer 200 can generate a second EFM by adding one or more other node elements to the IFM. The PGConv layer 200 can perform other MAC operations based on the second EFM and the convolutional kernel. For instance, the PGConv layer 200 may perform a first convolution operation based on the first EFM and the convolutional kernel, perform a second convolution operation based on the second EFM and another convolutional kernel. The PGConv layer 200 may further accumulate a result of the first convolution operation and a result of the second convolution operation.

### Example Method of Dynamic Point Grid Convolution

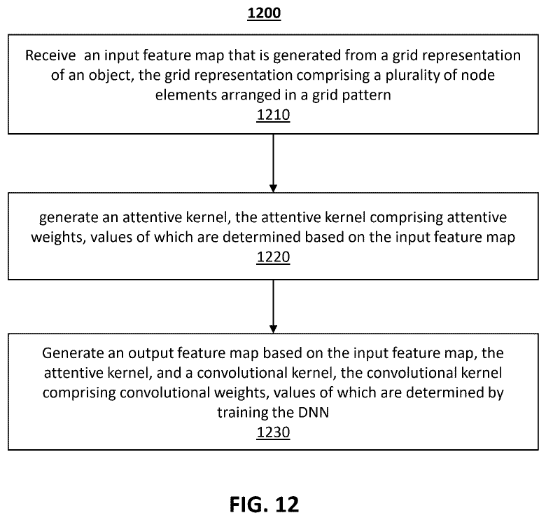

FIG. 12 is a flowchart showing a method 1200 of dynamic point grid convolution, in accordance with various embodiments. The method 1200 may be performed by the PGConv layer 200 in FIG. 2. Although the method 1200 is described with reference to the flowchart illustrated in FIG. 12, many other methods for dynamic point grid convolution may alternatively be used. For example, the order of execution of the steps in FIG. 12 may be changed. As another example, some of the steps may be changed, eliminated, or combined.

The PGConv layer 200 obtains 1210 an EFM that is generated from a grid representation of an object. The grid representation includes a plurality of node elements arranged in a grid pattern. The EFM may be generated by adding one or more additional node elements to the grid representation. The EFM includes the plurality of node elements and the one or more additional node elements.

The PGConv layer 200 generates an attentive kernel. The attentive kernel comprises attentive weights, values of which are determined based on the EFM. In some embodiments, the attentive kernel is a first attentive kernel, the PGConv layer 200 generates a second attentive kernel and a third attentive kernel. The three attentive kernels may have different dimensions. For instance, the PGConv layer 200 may determine a dimension of the first attentive kernel based on a dimension of the EFM, determine a dimension of the second attentive kernel based on a dimension of the convolutional kernel, and determine a dimension of the third attentive kernel based on a dimension of the OFM.

The PGConv layer 200 generates an OFM based on the EFM, the attentive kernel, and a convolutional kernel. The convolutional kernel includes convolutional weights, values of which are determined by training the DNN.

In embodiments where multiple attentive kernels a generated, the PGConv layer 200 may generate the OFM based on the multiple attentive kernels. The PGConv layer 200 may generate the OFM by performing element-wise multiplications on the first attentive kernel, the second attentive kernel, the third attentive kernel, and the convolutional kernel. The PGConv layer 200 may generate the OFM further by performing MAC operations on the EFM and a result of the element-wise multiplications.

In some embodiments, the EFM is a first EFM, the attentive kernel is a first attentive kernel including first attentive weights, values of which are determined based on the first EFM. The PGConv layer 200 may generate a second EFM based on the grid representation and generate a second attentive kernel that includes second attentive weights, values of which are determined based on the second EFM. The PGConv layer 200 may further generate the OFM further based on the second EFM and the second attentive kernel. In some embodiments, the first EFM includes the plurality of node elements that is arranged in a first grid pattern, the second EFM includes the plurality of node elements that is arranged in a second grid pattern, and the first grid pattern has a different shape from the second grid pattern. The first feature map includes a first node element in addition to the plurality of node elements. The second EFM includes a second node element in addition to the plurality of node elements, and the first node element has a different value from the second node element.

The PGConv layer 200 may generate the OFM by accumulating a result of a first convolution operation and a second convolution operation. The first convolution operation is based on the first EFM, the first attentive kernel, and the convolutional kernel. The second convolution operation is based on the second EFM, the second attentive kernel, and the convolutional kernel.

### Example Computing Device

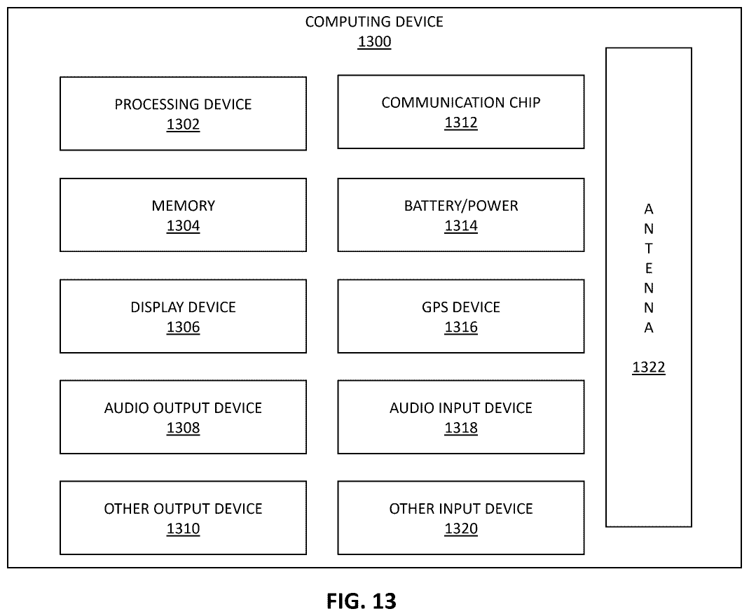

FIG. 13 is a block diagram of an example computing device 1300, in accordance with various embodiments. A number of components are illustrated in FIG. 13 as included in the computing device 1300, but any one or more of these components may be omitted or duplicated, as suitable for the application. In some embodiments, some or all of the components included in the computing device 1300 may be attached to one or more motherboards. In some embodiments, some or all of these components are fabricated onto a single system on a chip (SoC) die. Additionally, in various embodiments, the computing device 1300 may not include one or more of the components illustrated in FIG. 13, but the computing device 1300 may include interface circuitry for coupling to the one or more components. For example, the computing device 1300 may not include a display device 1306, but may include display device interface circuitry (e.g., a connector and driver circuitry) to which a display device 1306 may be coupled. In another set of examples, the computing device 1300 may not include an audio input device 1318 or an audio output device 1308, but may include audio input or output device interface circuitry (e.g., connectors and supporting circuitry) to which an audio input device 1318 or audio output device 1308 may be coupled.

The computing device 1300 may include a processing device 1302 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 1302 may include one or more digital signal processors (DSPs), application-specific ICs (ASICs), CPUs, GPUs, cryptoprocessors (specialized processors that execute cryptographic algorithms within hardware), server processors, or any other suitable processing devices. The computing device 1300 may include a memory 1304, which may itself include one or more memory devices such as volatile memory (e.g., DRAM), nonvolatile memory (e.g., read-only memory (ROM)), flash memory, solid state memory, and/or a hard drive. In some embodiments, the memory 1304 may include memory that shares a die with the processing device 1302. In some embodiments, the memory 1304 includes one or more non-transitory computer-readable media storing instructions executable to perform operations for point grid convolution, e.g., the method 1100 described above in conjunction with FIG. 11, the method 1200 described above in conjunction with FIG. 12, or the operations performed by the PGConv layer 200 described above in conjunction with FIG. 2. The instructions stored in the one or more non-transitory computer-readable media may be executed by the processing device 1302.

In some embodiments, the computing device 1300 may include a communication chip 1312 (e.g., one or more communication chips). For example, the communication chip 1312 may be configured for managing wireless communications for the transfer of data to and from the computing device 1300. The term “wireless” and its derivatives may be used to describe circuits, devices, DNN accelerators, methods, techniques, communications channels, etc., that may communicate data through the use of modulated electromagnetic radiation through a nonsolid medium. The term does not imply that the associated devices do not contain any wires, although in some embodiments they might not.

The communication chip 1312 may implement any of a number of wireless standards or protocols, including but not limited to Institute for Electrical and Electronic Engineers (IEEE) standards including Wi-Fi (IEEE 1302.13 family), IEEE 1302.16 standards (e.g., IEEE 1302.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 1302.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 1302.16 standards. The communication chip 1312 may operate in accordance with a Global system for Mobile Communication (GSM), General Packet Radio Service (GPRS), Universal Mobile Telecommunications system (UMTS), High Speed Packet Access (HSPA), Evolved HSPA (E-HSPA), or LTE network. The communication chip 1312 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1312 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1312 may operate in accordance with other wireless protocols in other embodiments. The computing device 1300 may include an antenna 1322 to facilitate wireless communications and/or to receive other wireless communications (such as AM or FM radio transmissions).

In some embodiments, the communication chip 1312 may manage wired communications, such as electrical, optical, or any other suitable communication protocols (e.g., the Ethernet). As noted above, the communication chip 1312 may include multiple communication chips. For instance, a first communication chip 1312 may be dedicated to shorter-range wireless communications such as Wi-Fi or Bluetooth, and a second communication chip 1312 may be dedicated to longer-range wireless communications such as global positioning system (GPS), EDGE, GPRS, CDMA, WIMAX, LTE, EV-DO, or others. In some embodiments, a first communication chip 1312 may be dedicated to wireless communications, and a second communication chip 1312 may be dedicated to wired communications.

The computing device 1300 may include battery/power circuitry 1314. The battery/power circuitry 1314 may include one or more energy storage devices (e.g., batteries or capacitors) and/or circuitry for coupling components of the computing device 1300 to an energy source separate from the computing device 1300 (e.g., AC line power).

The computing device 1300 may include a display device 1306 (or corresponding interface circuitry, as discussed above). The display device 1306 may include any visual indicators, such as a heads-up display, a computer monitor, a projector, a touchscreen display, a liquid crystal display (LCD), a light-emitting diode display, or a flat panel display, for example.

The computing device 1300 may include an audio output device 1308 (or corresponding interface circuitry, as discussed above). The audio output device 1308 may include any device that generates an audible indicator, such as speakers, headsets, or earbuds, for example.

The computing device 1300 may include an audio input device 1318 (or corresponding interface circuitry, as discussed above). The audio input device 1318 may include any device that generates a signal representative of a sound, such as microphones, microphone arrays, or digital instruments (e.g., instruments having a musical instrument digital interface (MIDI) output).

The computing device 1300 may include a GPS device 1316 (or corresponding interface circuitry, as discussed above). The GPS device 1316 may be in communication with a satellite-based system and may receive a location of the computing device 1300, as known in the art.

The computing device 1300 may include an other output device 1313 (or corresponding interface circuitry, as discussed above). Examples of the other output device 1313 may include an audio codec, a video codec, a printer, a wired or wireless transmitter for providing information to other devices, or an additional storage device.

The computing device 1300 may include an other input device 1320 (or corresponding interface circuitry, as discussed above). Examples of the other input device 1320 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1300 may have any desired form factor, such as a handheld or mobile computing system (e.g., a cell phone, a smart phone, a mobile internet device, a music player, a tablet computer, a laptop computer, a netbook computer, an ultrabook computer, a PDA, an ultramobile personal computer, etc.), a desktop computing system, a server or other networked computing component, a printer, a scanner, a monitor, a set-top box, an entertainment control unit, a vehicle control unit, a digital camera, a digital video recorder, or a wearable computing system. In some embodiments, the computing device 1300 may be any other electronic device that processes data.

### Select Examples

The following paragraphs provide various examples of the embodiments disclosed herein.
Example 1 provides a DNN, the DNN including a padding module configured to: receive an IFM including a grid representation of an object, the grid representation including a plurality of node elements arranged in a grid pattern, and generate an EFM by adding one or more additional node elements to the grid representation, the EFM including the plurality of node elements and the one or more additional node elements; and a convolution operator configured to generate an output feature map based on the EFM and a convolutional kernel, the convolutional kernel including convolutional weights, values of which are determined by training the DNN.
Example 2 provides the DNN of example 1, where the grid pattern is a two-dimensional grid pattern including a plurality of edges, and the padding module is configured to generate the EFM by adding the one or more additional node elements on at least one of the plurality of edges.
Example 3 provides the DNN of example 1, where an additional node element of the one or more additional node elements has a value of zero.
Example 4 provides the DNN of example 1, where an additional node element of the one or more additional node elements has a value of a node element of the plurality of node elements.
Example 5 provides the DNN of example 4, where the grid pattern is a two-dimensional grid pattern including a first edge and a second edge opposite the first edge, the node element is arranged on the first edge, and the padding module is configured to generate the EFM by adding the additional node element on the second edge.
Example 6 provides the DNN of example 1, where the EFM has a different grid pattern from the grid, and the plurality of node elements and the one or more additional node elements are arranged in the different grid pattern.
Example 7 provides the DNN of example 6, where the grid pattern is a two-dimensional grid pattern, and the EFM has a three-dimensional grid pattern.
Example 8 provides the DNN of example 6, where the EFM has a grid pattern, and the grid pattern has a torus shape or hollow cylinder shape.
Example 9 provides the DNN of example 1, where the EFM is a first EFM having a first grid pattern, the padding module is further configured to generate a second EFM by adding one or more other node elements to the grid representation, the second EFM having a second grid pattern that is different from the first grid pattern, and the convolution operator is further configured to perform other MAC operations based on the second EFM and the convolutional kernel.
Example 10 provides the DNN of example 9, where the convolution operator is configured to generate the OFM by performing a first convolution operation based on the first EFM and the convolutional kernel; performing a second convolution operation based on the second EFM and another convolutional kernel; and accumulating a result of the first convolution operation and a result of the second convolution operation.
Example 11 provides the DNN of example 1, where the convolutional weights are determined by training the DNN.
Example 12 provides the DNN of example 11, where the convolution operator is configured to generate the output feature map further based on an attentive kernel, and the attentive kernel comprises attentive weights that are determined based on the expanded feature map.
Example 13 provides the DNN of example 12, where the convolution operator is configured to generate the output feature map by performing element-wise multiplications on the convolution kernel and the attentive kernel.
Example 14 provides a method for DL by a DNN, the method including receiving an IFM including a grid representation of an object, the grid representation including a plurality of node elements arranged in a grid pattern; generating an EFM by adding one or more additional node elements to the grid representation, the EFM including the plurality of node elements and the one or more additional node elements; and generating an OFM based on the EFM and a convolutional kernel, the convolutional kernel including convolutional weights, values of which are determined by training the DNN.
Example 15 provides the method of example 14, where the grid pattern is a two-dimensional grid pattern including a plurality of edges, and adding the one or more additional node elements to the grid representation includes adding the one or more additional node elements on at least one of the plurality of edges.
Example 16 provides the method of example 14, where an additional node element of the one or more additional node elements has a value of zero.
Example 17 provides the method of example 14, where an additional node element of the one or more additional node elements has a value of a node element of the plurality of node elements.
Example 18 provides the method of example 17, where the grid pattern is a two-dimensional grid pattern including a first edge and a second edge opposite the first edge, the node element is arranged on the first edge, and adding the one or more additional node elements to the grid representation includes adding the additional node element on the second edge.
Example 19 provides the method of example 14, where the EFM has a different grid pattern from the grid, and the plurality of node elements and the one or more additional node elements are arranged in the different grid pattern.
Example 20 provides the method of example 19, where the grid pattern is a two-dimensional grid pattern, and the EFM has a three-dimensional grid pattern.
Example 21 provides the method of example 19, where the EFM has a grid pattern, and the grid pattern has a torus shape or hollow cylinder shape.
Example 22 provides the method of example 14, where the EFM is a first EFM having a first grid pattern, and the method further includes generating a second EFM by adding one or more other node elements to the grid representation, the second EFM having a second grid pattern that is different from the first grid pattern, and performing other MAC operations based on the second EFM and the convolutional kernel.
Example 23 provides the method of example 22, where generating the OFM includes performing a first convolution operation based on the first EFM and the convolutional kernel; performing a second convolution operation based on the second EFM and another convolutional kernel; and accumulating a result of the first convolution operation and a result of the second convolution operation.
Example 24 provides the method of example 14, where the convolutional weights are determined by training the DNN.
Example 25 provides the method of example 14, where generating the output feature map includes generating the output feature map further based on an attentive kernel, where the attentive kernel comprises attentive weights that are determined based on the expanded feature map.
Example 26 provides one or more non-transitory computer-readable media storing instructions executable to perform operations for DL, the operations including receiving an IFM including a grid representation of an object, the grid representation including a plurality of node elements arranged in a grid pattern; generating an EFM by adding one or more additional node elements to the grid representation, the EFM including the plurality of node elements and the one or more additional node elements; and generating an OFM based on the EFM and a convolutional kernel, the convolutional kernel including convolutional weights, values of which are determined by training the DNN.
Example 27 provides the one or more non-transitory computer-readable media of example 26, where the grid pattern is a two-dimensional grid pattern including a plurality of edges, and adding the one or more additional node elements to the grid representation includes adding the one or more additional node elements on at least one of the plurality of edges.
Example 28 provides the one or more non-transitory computer-readable media of example 26, where an additional node element of the one or more additional node elements has a value of zero.
Example 29 provides the one or more non-transitory computer-readable media of example 26, where an additional node element of the one or more additional node elements has a value of a node element of the plurality of node elements.
Example 30 provides the one or more non-transitory computer-readable media of example 26, where the EFM is a first EFM having a first grid pattern, and the operations further include generating a second EFM by adding one or more other node elements to the grid representation, the second EFM having a second grid pattern that is different from the first grid pattern, and performing other MAC operations based on the second EFM and the convolutional kernel.

### Additional Select Examples

Example 1 provides a DNN, the DNN including an attention module configured to receive an EFM that is generated from a grid representation of an object, the grid representation including a plurality of node elements arranged in a grid pattern, and generate an attentive kernel, the attentive kernel including attentive weights, values of which are determined based on the EFM; and a convolution operator configured to receive the EFM, receive the attentive kernel from the attention module, and generate an OFM based on the EFM, the attentive kernel, and a convolutional kernel, the convolutional kernel including convolutional weights, values of which are determined by training the DNN.
Example 2 provides the method of example 1, where the attention module is configured to generate the attentive kernel based on dimensions of the convolutional kernel.
Example 3 provides the method of example 2, where the convolution operator is configured to generate the OFM by performing element-wise multiplications on the attentive kernel and the convolutional kernel.
Example 4 provides the method of example 3, where the attention module is configured to determine dimensions of the attentive kernel based on one or more dimensions of the EFM and a dimension of the convolutional kernel.
Example 5 provides the method of example 3, where the convolution operator is configured to generate the OFM further by performing multiply-accumulate (MAC) operations on the EFM and a result of the element-wise multiplications.
Example 6 provides the method of example 1, where the EFM is a first EFM, the attentive kernel is a first attentive kernel including first attentive weights, values of which are determined based on the first EFM, the attention module is further configured to receive a second EFM generated based on the grid representation and to generate a second attentive kernel that includes second attentive weights, values of which are determined based on the second EFM, and the convolution operator is configured to generate the OFM further based on the second EFM and the second attentive kernel.
Example 7 provides the method of example 6, where the first EFM includes the plurality of node elements that is arranged in a first grid pattern, the second EFM includes the plurality of node elements that is arranged in a second grid pattern, and the first grid pattern has a different shape from the second grid pattern.
Example 8 provides the method of example 6, where the first EFM includes a first node element in addition to the plurality of node elements, the second EFM includes a second node element in addition to the plurality of node elements, and the first node element has a different value from the second node element.
Example 9 provides the method of example 6, where the convolution operator is configured to generate the OFM by accumulating a result of a first convolution operation and a second convolution operation, the first convolution operation is based on the first EFM, the first attentive kernel, and the convolutional kernel, and the second convolution operation is based on the second EFM, the second attentive kernel, and the convolutional kernel.
Example 10 provides the method of example 1, where the EFM is generated by adding one or more additional node elements to the grid representation, and the EFM includes the plurality of node elements and the one or more additional node elements.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A deep neural network (DNN), the DNN comprising:
a padding module configured to:
receive an input feature map including a grid representation of an object, the grid representation comprising a plurality of node elements arranged in a grid pattern, and
generate an expanded feature map by adding one or more additional node elements to the grid representation, the expanded feature map including the plurality of node elements and the one or more additional node elements; and
a convolution operator configured to generate an output feature map based on the expanded feature map and a convolutional kernel, the convolutional kernel comprising convolutional weights.

2. The DNN of claim 1, wherein the grid pattern is a two-dimensional grid pattern including a plurality of edges, and the padding module is configured to generate the expanded feature map by adding the one or more additional node elements on at least one of the plurality of edges.

3. The DNN of claim 1, wherein an additional node element of the one or more additional node elements has a value of zero.

4. The DNN of claim 1, wherein an additional node element of the one or more additional node elements has a value of a node element of the plurality of node elements.

5. The DNN of claim 4, wherein the grid pattern is a two-dimensional grid pattern including a first edge and a second edge opposite the first edge, the node element is arranged on the first edge, and the padding module is configured to generate the expanded feature map by adding the additional node element on the second edge.

6. The DNN of claim 1, wherein the expanded feature map has a different grid pattern from the grid, and the plurality of node elements and the one or more additional node elements are arranged in the different grid pattern.

7. The DNN of claim 6, wherein the grid pattern is a two-dimensional grid pattern, and the expanded feature map has a three-dimensional grid pattern.

8. The DNN of claim 6, wherein the different grid pattern has a torus shape or hollow cylinder shape.

9. The DNN of claim 1, wherein:
the expanded feature map is a first expanded feature map having a first grid pattern,
the padding module is further configured to generate a second expanded feature map by adding one or more other node elements to the grid representation, the second expanded feature map having a second grid pattern that is different from the first grid pattern, and
the convolution operator is further configured to perform other MAC operations based on the second expanded feature map and the convolutional kernel.

10. The DNN of claim 9, wherein the convolution operator is configured to generate the output feature map by:
performing a first convolution operation based on the first expanded feature map and the convolutional kernel;
performing a second convolution operation based on the second expanded feature map and another convolutional kernel; and
accumulating a result of the first convolution operation and a result of the second convolution operation.

11. The DNN of claim 1, wherein the convolution operator is configured to generate the output feature map further based on an attentive kernel, the attentive kernel comprises attentive weights that are determined based on the expanded feature map, and the convolution operator is configured to generate the output feature map by performing element-wise multiplications on the convolution kernel and the attentive kernel.

12. A method for deep learning by a deep neural network (DNN), the method comprising:
receiving an input feature map including a grid representation of an object, the grid representation comprising a plurality of node elements arranged in a grid pattern; and
generating an expanded feature map by adding one or more additional node elements to the grid representation, the expanded feature map including the plurality of node elements and the one or more additional node elements; and
generating an output feature map based on the expanded feature map and a convolutional kernel, the convolutional kernel comprising convolutional weights.

13. The method of claim 12, wherein the grid pattern is a two-dimensional grid pattern including a plurality of edges, and adding the one or more additional node elements to the grid representation comprises adding the one or more additional node elements on at least one of the plurality of edges.

14. The method of claim 12, wherein an additional node element of the one or more additional node elements has a value of zero.

15. The method of claim 12, wherein an additional node element of the one or more additional node elements has a value of a node element of the plurality of node elements.

16. The method of claim 15, wherein the grid pattern is a two-dimensional grid pattern including a first edge and a second edge opposite the first edge, the node element is arranged on the first edge, and adding the one or more additional node elements to the grid representation comprises adding the additional node element on the second edge.

17. The method of claim 12, wherein the expanded feature map has a different grid pattern from the grid, and the plurality of node elements and the one or more additional node elements are arranged in the different grid pattern.

18. The method of claim 12, wherein the expanded feature map is a first expanded feature map having a first grid pattern, and the method further comprises:
generating a second expanded feature map by adding one or more other node elements to the grid representation, the second expanded feature map having a second grid pattern that is different from the first grid pattern, and
performing other MAC operations based on the second expanded feature map and the convolutional kernel.

19. The method of claim 18, wherein generating the output feature map comprises:
performing a first convolution operation based on the first expanded feature map and the convolutional kernel;
performing a second convolution operation based on the second expanded feature map and another convolutional kernel; and
accumulating a result of the first convolution operation and a result of the second convolution operation.

20. The method of claim 12, wherein generating the output feature map comprises:
generating the output feature map further based on an attentive kernel, wherein the attentive kernel comprises attentive weights that are determined based on the expanded feature map.
